(19) United States
(12) Patent Application Publication
(10) Pub. No.: US 2025/0173814 A1
(43) Pub. Date: May 29, 2025

(54) METHODS, SYSTEMS, AND STORAGE MEDIUM FOR IMAGE REGISTRATION

(71) Applicant: SHANGHAI UNITED IMAGING HEALTHCARE CO., LTD., Shanghai (CN)

(72) Inventors: Fenggang JIA, Shanghai (CN); Wenjun YU, Shanghai (CN); Bingbing ZHAO, Shanghai (CN)

(73) Assignee: SHANGHAI UNITED IMAGING HEALTHCARE CO., LTD., Shanghai (CN)

(21) Appl. No.: 19/031,398

(22) Filed: Jan. 18, 2025

Related U.S. Application Data
(63) Continuation of application No. PCT/CN2023/122743, filed on Sep. 28, 2023.

(30) Foreign Application Priority Data
Sep. 30, 2022 (CN) 202211213847.9
Sep. 30, 2022 (CN) 202211215151.X

(51) Int. Cl. G06T 3/14; G06T 7/33

(52) U.S. Cl. CPC G06T 3/14; G06T 7/337; G06T 7/344; G06T 2200/24

(57) ABSTRACT

A method and system for visual registration of an image are provided. The method may include obtaining multiple images; establishing a registration relationship model including multiple registration relationships each of which is of at least two of the multiple images; and displaying at least a portion of the multiple registration relationships on a user interface, wherein one of the multiple registration relationships presents at least one of a registration mode, a registration direction, or a reference image for registration of at least two of the multiple images.

### CROSS-REFERENCE TO RELATED APPLICATIONS

This application is a Continuation of International Application No. PCT/CN2023/122743, filed on Sep. 28, 2023, which claims priority to the Chinese Patent Application No. 202211215151.X, filed on Sep. 30, 2022, and Chinese Patent Application No. 202211213847.9, filed on Sep. 30, 2022, the contents of each of which are hereby incorporated by reference.

### TECHNICAL FIELD

The present disclosure relates to a medical technology field, in particular, relates to systems and methods for image registration.

### BACKGROUND

With an advancement of medical imaging technology, doctors may make clinical diagnoses by integrating information from multiple images to obtain comprehensive information, thereby improving the accuracy of diagnosis. To integrate information from multiple images, different images need to be registered in the same space for comparative observation. With an increasing number and variety of images in a current environment, if all images need to be registered, the times of registrations may explode, which leads to a long registration time and a chaotic relationship between images. And if there are registration failures, it is difficult for users to troubleshoot of reasons for the registration failure and adjust a registration relationship. Especially in the registration of multi-modality images, the image modalities used for fusion may be complex and diverse, the field of view of the acquired images may vary greatly, the quality of the images used for fusion may vary, the large number of images used for fusion may be difficult to manage, registration of the images scanned by different scanners may be difficult, etc.

Therefore, it is desirable to provide a system and a method for image registration that can reduce the difficulty of registration in multiple images and improve registration quality.

### SUMMARY

One aspect of embodiments of the present disclosure may provide a system. The system may include at least one storage medium including a set of instructions; at least one processor in communication with the at least one storage medium, wherein when executing the set of instructions, the at least one processor is directed to cause the system to perform operations including: obtaining multiple images; establishing a registration relationship model including multiple registration relationships each of which is of at least two of the multiple images; and displaying at least a portion of the multiple registration relationships on a user interface, wherein one of the multiple registration relationships may present at least one of a registration mode, a registration direction, or a reference image for registration of at least two of the multiple images.

In some embodiments, the operations further include obtaining a user operation inputted by a user via the user interface; and adjusting the registration relationship model based on the user operation, wherein adjustment of the registration relationship model may include at least one of: modifying at least one of the multiple registration relationships; adding a registration relationship of at least two of the multiple images; or deleting a registration relationship of at least two of the multiple images.

In some embodiments, the modifying at least one of the multiple registration relationships may include: changing at least one of a registration mode, the registration direction, the reference image for registration, or an image to be registered in the at least one of the multiple registration relationships.

In some embodiments, the user interface may include a first visual window configured displaying of at least one of the multiple images and a second visual window configured for management of the registration relationship model, and the operations may further include: in response to receipt of a selection operation of the user via the first visual window, displaying at least two of the multiple images according to the selection operation; opening the second visual window; and managing a registration relationship of the at least two of the multiple images via the second visual window.

In some embodiments, the operations may further include obtaining a registration result of the at least two of the multiple images that is determined based on the registration relationship; in response to receipt of an adjusting operation of the user via the second visual window, adjusting the registration result of the at least two of the multiple images.

In some embodiments, the registration relationship of at least two of the multiple images may be presented on the user interface by a line connecting the at least two of the multiple images, and different colors or types of lines representing different registration modes.

In some embodiments, the line may denote the registration direction directing from an image to be registered to the reference image among the at least two of the multiple images.

In some embodiments, the reference image may be highlighted on the user interface.

In some embodiments, the registration mode may include a first registration process based on position information of the multiple images and a second registration process based on gray-level information of the multiple images.

In some embodiments, the operations may further include classifying the multiple images into multiple groups, and the registration relationships of images in a same group presenting a same reference image.

In some embodiments, the classifying the multiple images into multiple groups may be performed by: images in the same group representing a same portion of a subject, images in the same group corresponding to a same coordinate system, images in the same group being acquired by a same scanner, images in the same group is acquired according to one or more same scanning parameters.

Another aspect of embodiments of the present disclosure may provide a system. The system may include at least one storage medium including a set of instructions; at least one processor in communication with the at least one storage medium, wherein when executing the set of instructions, the at least one processor is directed to cause the system to perform operations including: obtaining multiple images; classifying the multiple images into multiple groups; for each group of images, obtaining a first registration result by registering multiple images in the same group; for different groups of images, obtaining a second registration result by registering multiple reference images each of which belongs to one of the different groups of images; and fusing the multiple images based on the first registration result and the second registration result.

In some embodiments, images in a same group may represent a same portion of a subject.

In some embodiments, images in a same group may correspond to a same coordinate system.

In some embodiments, images in a same group may be acquired by a same scanner.

In some embodiments, images in a same group may be acquired according to one or more same scanning parameters.

In some embodiments, the multiple reference images in one group of images may correspond to a maximum field of view among the one group of images.

In some embodiments, the multiple reference images in one group of images may correspond to a maximum resolution among the one group of images.

In some embodiments, the obtaining a first registration result by registering multiple images in the same group may include: registering each image in the group of images with the reference image in the group of images by a first registration process performed based on position information and a second registration process based on gray-level information.

In some embodiments, the first registration process may be performed by operations including: for two reference images, determining one or more reference points from each of the two reference images; matching the one or more reference points determined from each of the two reference images to obtain corresponding reference points in the two reference images; and determining an initial transformation relationship between a first coordinate system and a second coordinate system applied to the two reference images, respectively, based on the corresponding reference points.

In some embodiments, the second registration process may be performed by operations including: determining a transformed image by performing an image transform on one of the two reference images based on an intermediate transformation relationship determined based on the initial transformation relationship; determining a similarity degree between the transformed image and another one of the two reference images; determining whether the similarity degree satisfies a condition; in response to determining that the similarity degree does not satisfy the condition, updating the intermediate transformation relationship until the similarity degree determined based on the updated intermediate transformation relationship satisfies the condition; and designating the updated intermediate transformation relationship as the target transformation relationship between the first coordinate system and the second coordinate system.

Another aspect of embodiments of the present disclosure may provide a system. The system may include at least one storage medium including a set of instructions; at least one processor in communication with the at least one storage medium, wherein when executing the set of instructions, the at least one processor is directed to cause the system to perform operations including: obtaining multiple images; obtaining a first registration result based on position information of the multiple images; obtaining a second registration result based on gray-level information of the multiple images and the first registration result; and fusing the multiple images based on the first registration result and the second registration result.

Another aspect of embodiments of the present disclosure may provide a method. The method may include obtaining multiple images; establishing a registration relationship model including multiple registration relationships each of which is of at least two of the multiple images; and displaying at least a portion of the multiple registration relationships on a user interface, wherein one of the multiple registration relationships may present at least one of a registration mode, a registration direction, or a reference image for registration of at least two of the multiple images.

Another aspect of embodiments of the present disclosure may provide a non-transitory computer readable medium. The non-transitory computer readable medium may include a set of instructions, wherein when executed by at least one processor, the set of instructions direct the at least one processor to perform acts of: obtaining multiple images; establishing a registration relationship model including multiple registration relationships each of which is of at least two of the multiple images; and displaying at least a portion of the multiple registration relationships on a user interface, wherein one of the multiple registration relationships may present at least one of a registration mode, a registration direction, or a reference image for registration of at least two of the multiple images.

Another aspect of embodiments of the present disclosure may provide a method. The method may include obtaining multiple images; classifying the multiple images into multiple groups; for each group of images, obtaining a first registration result by registering multiple images in the same group; for different groups of images, obtaining a second registration result by registering multiple reference images each of which belongs to one of the different groups of images; and fusing the multiple images based on the first registration result and the second registration result.

Another aspect of embodiments of the present disclosure may provide a non-transitory computer readable medium. The non-transitory computer readable medium may include a set of instructions, wherein when executed by at least one processor, the set of instructions direct the at least one processor to perform acts of: obtaining multiple images; classifying the multiple images into multiple groups; for each group of images, obtaining a first registration result by registering multiple images in the same group; for different groups of images, obtaining a second registration result by registering multiple reference images each of which belongs to one of the different groups of images; and fusing the multiple images based on the first registration result and the second registration result.

Another aspect of embodiments of the present disclosure may provide a method. The method may include obtaining multiple images; obtaining a first registration result based on position information of the multiple images; obtaining a second registration result based on gray-level information of the multiple images and the first registration result; and fusing the multiple images based on the first registration result and the second registration result.

Another aspect of embodiments of the present disclosure may provide a non-transitory computer readable medium. The non-transitory computer readable medium may include a set of instructions, wherein when executed by at least one processor, the set of instructions direct the at least one processor to perform acts of: obtaining multiple images; obtaining a first registration result based on position information of the multiple images; obtaining a second registration result based on gray-level information of the multiple images and the first registration result; and fusing the multiple images based on the first registration result and the second registration result.

Another aspect of embodiments of the present disclosure may provide a system. The system may include a terminal device including a user interface configured to facilitate a communication between a user and one or more components of the system, wherein the user interface may be configured for management of a registration relationship model of multiple images, the registration relationship model may include multiple registration relationships each of which is of at least two of the multiple images.

In some embodiments, the user interface may include: a first visual window and a second visual window, the first visual window may be configured for displaying of at least one of multiple images, and the second visual window may be configured for management of the registration relationship model.

In some embodiments, the management of the registration relationship model may include at least one of: displaying at least a portion of the multiple registration relationships; modifying at least one of the multiple registration relationships; adding a registration relationship of at least two of the multiple images; or deleting a registration relationship of at least two of the multiple images.

In some embodiments, a registration relationship of at least two of the multiple images may be presented on the user interface by a line connecting the at least two of the multiple images, and different colors or types of lines representing different registration modes.

In some embodiments, the line may denote the registration direction directing from an image to be registered to a reference image among the at least two of the multiple images. In some embodiments, the reference image may be highlighted on the user interface.

### BRIEF DESCRIPTION OF THE DRAWINGS

The present disclosure is further describable in terms of exemplary embodiments. These exemplary embodiments are describable in detail with reference to the drawings. These embodiments are non-limiting exemplary embodiments, in which like reference numerals represent similar structures throughout the several views of the drawings, and wherein:

FIG. 1 is a schematic diagram illustrating an exemplary application scenario of a system for image registration according to some embodiments of the present disclosure;

FIG. 2 is a flowchart illustrating an exemplary process for image registration according to some embodiments of the present disclosure;

FIG. 3 is a schematic diagram illustrating an exemplary visual interface of registration relationships according to some embodiments of the present disclosure;

FIG. 4 is a schematic diagram illustrating an exemplary visualization process for modifying a registration relationship according to some embodiments of the present disclosure;

FIG. 5 is a schematic diagram illustrating an exemplary visualization process for deleting a registration relationship according to some embodiments of the present disclosure;

FIG. 6 is a schematic diagram illustrating an exemplary visualization process for adding a registration relationship according to some embodiments of the present disclosure;

FIG. 7 is a flowchart illustrating an exemplary process for fusing images according to some embodiments of the present disclosure;

FIG. 8 is a schematic diagram illustrating an exemplary process for fusing images according to some embodiments of the present disclosure;

FIG. 9 is a schematic diagram illustrating an exemplary process for registering based on position information of images according to some embodiments of the present disclosure;

FIG. 10 is a flowchart illustrating an exemplary process for fusing images according to some embodiments of the present disclosure;

FIG. 11 is a schematic diagram illustrating an exemplary processing device of a system for image registration according to some embodiments of the present disclosure;

FIG. 12 is a schematic diagram illustrating an exemplary module of a system for image registration according to some embodiments of the present disclosure; and

FIG. 13 is a schematic diagram illustrating an exemplary module of an image fusion system according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been describable at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assemblies of different levels in ascending order. However, the terms may be displaced by other expressions if they achieve the same purpose.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

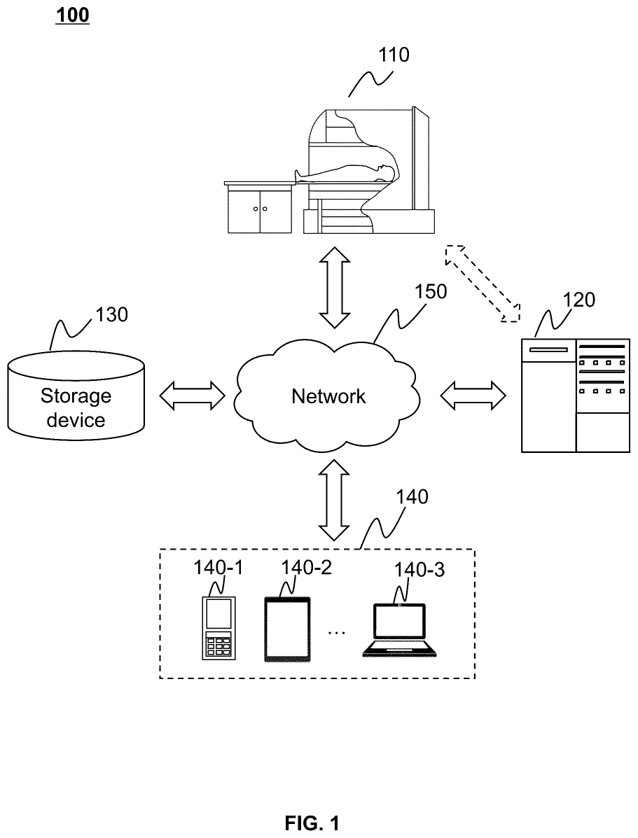

FIG. 1 is a schematic diagram illustrating an exemplary application scenario of a system for image registration according to some embodiments of the present disclosure.

As shown in FIG. 1, in some embodiments, the system 100 may include an imaging device 110, a processing device 120, a storage device 130, a terminal 140, and a network 150.

The imaging device 110 may be configured to obtain image data of a subject. In some embodiments, the imaging device 110 may be a medical imaging device capable of imaging a specific portion of a patient. For example, the imaging device 110 may include a computed tomography (CT) scanner, a magnetic resonance imaging (MRI) scanner, a positron emission tomography (PET) scanner, or the like, or any combination thereof. The imaging device 110 provided above is for illustrative purposes only and is not limited in scope. In some embodiments, the imaging device 110 may include multiple different types of medical imaging devices for acquiring multiple images of different modalities.

In some embodiments, the imaging device 110 may include a visual imaging device, an infrared imaging device, a radar imaging device, etc.

In some embodiments, the imaging device 110 may send the acquired image to the processing device 120. The imaging device 110 may receive instructions sent by doctors through the terminal 140, and perform related operations based on the instructions, such as scanning and imaging. In some embodiments, the imaging device 110 may exchange data and/or information with other components in the system 100 (e.g., the processing device 120, the storage device 130, the terminal 140) through the network 150. In some embodiments, the imaging device 110 may be directly connected to other components in the system 100. In some embodiments, the imaging device 110 may include one or more components (e.g., the processing device 120, the storage device 130) in the system 100.

The processing device 120 may process data and/or information obtained from components in other devices or system, based on the data, information and/or processing results, perform the methods for visual registration of the image and/or fusion of images shown in some embodiments of the present disclosure to complete one or more of the functions described in some embodiments of the present disclosure. For example, the processing device 120 may classify multiple images into multiple groups. As another example, the processing device 120 may obtain the registration relationships of the multiple images and then visualize the registration relationships. In some embodiments, the processing device 120 may obtain one or more user operations on the registration relationship inputted via the user interface and adjust the registration relationship between two images based on the operations. The user interface may visualize the registration relationship. The user interface may also be referred to as a visual interface. For example, when the user interface display registration relationships, the user interface may be a visual interface of the registration relationships. In some embodiments, the processing device 120 may perform coarse-to-fine registrations of images, thereby obtaining a registration result, such as registration matrices, or the like. In some embodiments, the processing device 120 may send the registration relationships to the terminal 140 for users (e.g., doctors) to browse and adjust. In some embodiments, the processing device 120 may receive instructions sent by the users through the user interface of the terminal 140 to adjust the registration relationships.

In some embodiments, the processing device 120 may include one or more sub-processing devices (e.g., a single-core processing device or multi-core processing device). Merely for example, the processing device 120 may include a central processing unit (CPU), a specialized integrated circuit (ASIC), a specialized instruction processor (ASIP), a graphics processor (GPU), a physical processor (PPU), a digital signal processor (DSP), a field programmable gate array (FPGA), a programmable logic circuit (PLD), a controller, a microcontroller unit, a reduced instruction set computer (RISC), a microprocessor, or any combination thereof.

The storage device 130 may store data or information generated by other devices. In some embodiments, the storage device 130 may store data and/or information acquired by the imaging device 110, such as a multimodal image. In some embodiments, the storage device 130 may store data and/or information processed by the processing device 120, such as the registration relationship between images. The storage device 130 may include one or more storage components, each of which may be an independent device or a part of other devices. The storage device may be local or implemented through the cloud.

The terminal 140 may facilitate communication between the user and other components (e.g., the imaging device 110, the processing device 120, the storage device 130) of the system 100. The terminal 140 may include a user interface. The user interface may facilitate interaction between the user and the other components (e.g., the imaging device 110, the processing device 120, the storage device 130).

For example, the user may input a control instruction through the user interface, and the control instruction may be used to control an operation of the imaging device 110. The control instruction may enable the imaging device 110 to complete a designated operation, such as scanning and imaging of a specific body portion of a patient. As another example, the user may input a request instruction through the terminal 140 and the request instruction may instruct the processing device 120 to perform the registration of the images as shown in some embodiments of the present disclosure.

As still another example, the terminal 140 may receive information and/or data from other components (e.g., the imaging device 110, the processing device 120, the storage device 130) of the system 100 and display the information and/or data on the user interface. For example, the terminal 140 may receive multiple images from the imaging device 110 or the processing device 120 and display the multiple images via the user interface. As another example, the terminal 140 may receive a registration model including multiple registration relationships of the multiple images from the processing device 120 and display the multiple registration relationships via the user interface.

As a further example, a user may manage the multiple registration relationships via the user interface. The terminal 140 may receive the registration relationships of the multiple images from the processing device 120, and display the registration relationships on the display screen via the user interface, allowing the doctors to accurately grasp the registration relationships of the multiple images for effective and targeted examination and/or treatment of a subject.

In some embodiments, the user may issue an operating instruction to the processing device 120 and adjust one or more registration relationships through the user interface of the registration relationships displayed on the display screen of the terminal 140. In some embodiments, the terminal 140 may be one or any combination of other devices with display screen, input and/or output functions, such as mobile devices 140-1, tablet computers 140-2, laptop computers 140-3, desktop computers, or the like.

The network 150 may connect various components of the system and/or connect the system with external resource parts. The network 150 may enable communication between various components and with other parts outside the system, promoting the exchange of data and/or information. In some embodiments, one or more components in the system 100 (e.g., the imaging device 110, the processing device 120, the storage device 130, the terminal 140) may send data and/or information to other components through the network 150. In some embodiments, the network 150 may be any one or more of wired or wireless networks.

It should be noted that the above description is provided for illustrative purposes only and is not intended to limit the scope of this specification. For ordinary technical personnel in this field, various changes and modifications can be made under the guidance of the content of the present disclosure. The features, structures, methods, and other features of the exemplary embodiments described in the present disclosure can be combined in various ways to obtain additional and/or alternative exemplary embodiments. For example, the processing device 120 may be based on cloud computing platforms, such as public clouds, private clouds, communities, and hybrid clouds. However, these changes and modifications will not deviate from the scope of the present disclosure.

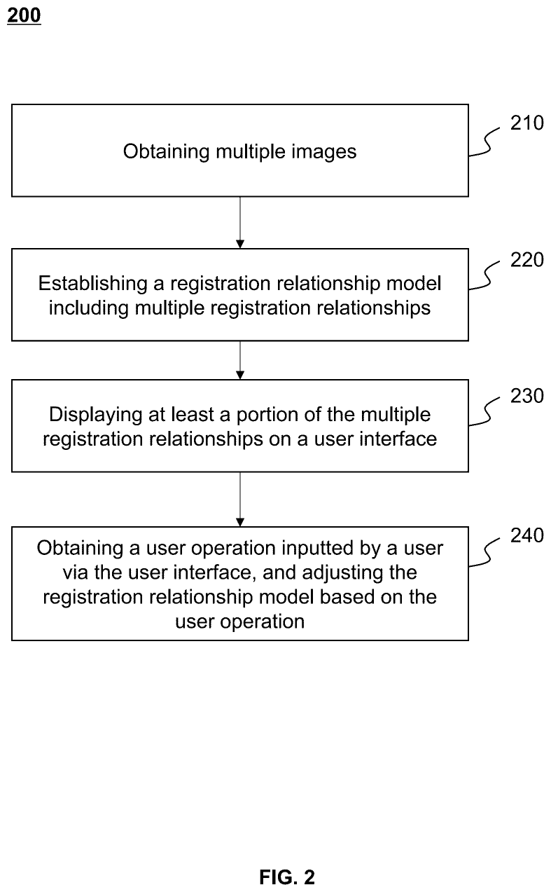

FIG. 2 is a flowchart illustrating an exemplary process for registration of multiple images according to some embodiments of the present disclosure.

As shown in FIG. 2, the process 200 may include the following operations. In some embodiments, process 200 may be executed by the processing device 120.

In 210, multiple images may be obtained. One of the multiple images may include a medical image, a visible light image, an infrared image, a radar image, etc. For example, the multiple images may be medical images.

The medical image refers to an image obtained by the medical imaging device scanning a target object (e.g., a human body, a phantom, etc.). For example, the medical image may include a CT image, an MRI image, a PET image, or the like. In the field of the medical imaging, images of multiple modalities, acquired in multiple scans or examinations, and/or acquired in different bed positions may be registered into the same coordinate space for comparative observation, and different image information from the images may be integrated to make a more comprehensive clinical diagnosis.

For example, the processing device 120 may obtain the multiple images through different modalities of medical imaging devices. For example, different modalities of the medical imaging devices may include a CT scanner, an MRI scanner, a PET scanner, or the like. As a further example, the processing device 120 may obtain scanning data from each of the multiple medical imaging devices in different modalities and reconstruct the multiple images based on the scanning data.

As another example, the processing device 120 may obtain the multiple images acquired during multiple examinations or scans of the same object (e.g., the same patient), such as examination images obtained during multiple hospitalizations of a patient. The multiple examinations may be performed at different times, such as on different days. In some embodiments, one single examination may include multiple scans. For example, the multiple scans may be performed according to different scanning parameters (e.g., a scanning sequence used in an MR scan). As a further example, the processing device 120 may obtain the images acquired by an MR scanner according to multiple scan sequences of the target object in a single examination, such as images obtained by scan sequences T1, T2, DWI, and other scan sequences in an MRI examination.

In some embodiments, the processing device 120 may obtain the images through other means, such as obtaining from various data sources such as the storage device.

In 220, a registration relationship model including multiple registration relationships of the multiple images may be established. Each of the multiple registration relationships may be between two images of the multiple images.

A registration relationship between two images may indicate registration information between the two images. For example, the registration relationship may include a registration mode, a registration direction, a reference image for registration among the two images of the multiple images, or the like, or a combination thereof.

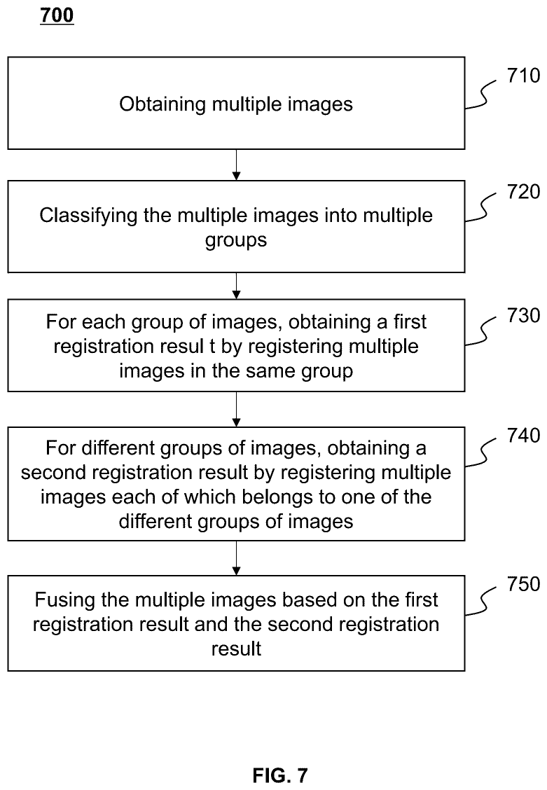

The registration mode refers to a registration technique used for registration between the two images. In some embodiments, the registration mode may include using a coordinate alignment registration algorithm, a grayscale-based registration algorithm, an image feature-based registration algorithm, a position-based registration algorithm (e.g., a deep learning-based registration algorithm of key point positioning), a manual registration technique, or other registration techniques as described in the present disclosure. For example, a registration technique may include a coarse registration process (e.g., the first registration process as described in FIG. 7) and a fine registration process (e.g., the second registration process as described in FIG. 7). The coarse registration process may include performing registration on two images based on the position information of the two images. The fine registration process may include performing registration on two images based on gray-level information of the two images. As another example, a registration technique may include a coarse registration process (e.g., the first registration process as described in FIG. 7). As still another example, a registration technique may include a fine registration process (e.g., the second registration process as described in FIG. 7).

The coordinate alignment registration refers to a transformation of the reference image and a floating image among the two images into the same coordinate system. The registration using the registration algorithm refers to registration that uses various registration algorithms (e.g., a grayscale-based registration algorithm, an image feature-based registration algorithm, etc.) for registration.

The manual registration refers to registration performed by a user. For example, the registration result between two images may be adjusted by the user manually.

More descriptions of the registration mode, the coarse registration process, and the fine registration process may be found in FIG. 7 and related descriptions.

In some embodiments, the registration direction of the registration relationship between two images may be configured to indicate whether the registration between the two images is performed by registering a first image of the two images to a second image of the two images or registering the second image to the first image. If the first image is registered to the second image, the second image may be a reference image for registration, and the first image is a floating image; if the second image is registered to the first image, the first image may be a reference image for registration, and the second image is a floating image.

In some embodiments, the multiple images may have different registration relationships. For example, a first portion of the multiple images may have the same first registration relationship and a second portion of the multiple images may have the same second registration relationship. The first portion may have one or more same images as the second portion, or images in the first portion may be different from images in the second portion. The first registration relationship may be different from the second registration relationship in at least one of a registration mode, a registration direction, or a reference image for registration. In some embodiments, one image among the multiple images may have a first registration relationship with a first image among the multiple images. In some embodiments, the one image among the multiple images may have a second registration relationship with a second image among the multiple images. The first registration relationship may be the same or different from the second registration relationship.

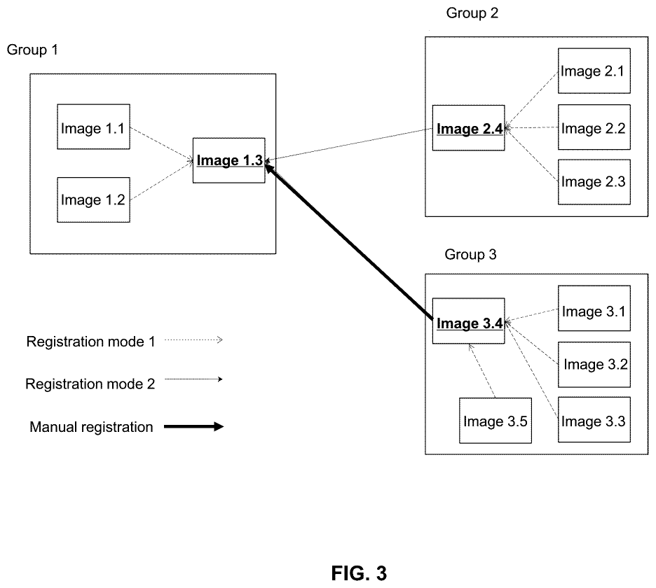

In some embodiments, the processing device 120 may group the multiple images based on the registration relationships of the multiple images, and the number of groups may be one or more. Specifically, the multiple images that have registration relationships with the same reference image may be classified into a group. In other words, images in the same group except the reference image may be registered to the reference image. For example, as shown in FIG. 3, image 1.1, image 1.2, and image 1.3 may be classified as group 1, and both image 1.1 and image 1.2 may be registered to image 1.3; image 2.1, image 2.2, image 2.3, and image 2.4 may be classified as group 2, and image 2.1, image 2.2, and image 2.3 may be registered to image 2.4; image 3.1, image 3.2, an image 3.3, image 3.5, and image 3.4 may be classified as group 3, and image 3.1, image 3.2, image 3.3, and image 3.5 may be registered to image 3.4.

In some embodiments, the processing device 120 may group the multiple images based on a rule. Specifically, the processing device 120 may classify the multiple images into multiple groups based on: images in the same group representing a same portion of a subject, images in the same group corresponding to a same coordinate system, images in the same group being acquired by a same scanner, images in the same group is acquired according to one or more same scanning parameters. More descriptions of grouping the multiple images may be found in operation 720 and related descriptions, which may not be limited herein.

In some embodiments, the registration relationships of images in the same group may be the same in the registration technique. In some embodiments, the registration relationships of images in the same group may be different in the registration techniques.

In some embodiments, the processing device 120 may determine the multiple registration relationships based on user inputs via a user interface. For example, the user may designate the registration technique, the registration direction, and/or the reference image between two images via the user interface. In some embodiments, the multiple registration relationships may be determined based on a default setting of the system 100. For example, the system 100 may determine images acquired based on the same imaging device among the multiple images, determine a reference image with a higher image quality from the multiple images, and establish registration relationships of the reference image and other images. The processing device 120 may combine the registration relationships into a registration relationship model. As used herein, the image quality of an image may be denoted by one or more evaluation parameters. The one or more evaluation parameters may include an image noise level, an image contrast, a signal-to-noise ratio (SNR) of an image, an artifact level of an image, an image resolution, etc.

In some embodiments, the registration relationship model may be in the form of a network including multiple nodes representing the multiple images. A node may represent an image. The node may include a pointer pointing to a storage address. The image may be called by clicking the node via the user interface. Two nodes representing two images that have a registration relationship may be connected via a line with arrow. In some embodiments, the nodes may be constructed based on a function that is used to register two images the nodes represent.

In some embodiments, the registration relationship model may be in a form a table including multiple image identifiers (e.g., an image number) and corresponding registration relationships. For example, one column of the table may include image numbers, and one column may include numbers of reference images, and one column may include registration techniques. Each of the image numbers may correspond to one of the numbers of reference images and one or more registration techniques.

In some embodiments, the processing device 120 may display the registration relationship based on search information input by the user (e.g., keyword, etc.), i.e., displaying a registration relationship that matches the search information. In some embodiments, the processing device 120 may display a portion of registration relationships as collapsed. For example, a preset count of registration relationships (e.g., 5, 10, etc.) may be displayed and other registration relationships may be displayed as collapsed. As another example, registration relationships that the user are not interested in or does not match the search information may be displayed as collapsed. As still another example, registration relationships of images in one group may be displayed and registration relationships of images in one group may be collapsed.

In 230, at least a portion of the multiple registration relationships may be displayed on a user interface.

In some embodiments, the processing device 120 may display parts or all of the obtained registration relationships on the user interface, that is, visualize the registration relationships. Specifically, some or parts of the obtained registration relationships may be displayed on the user interface.

In some embodiments, the user interface may include a first visual window and a second visual window. The first visual window may be configured to display at least one of the multiple images, and the second visual window may be configured to display and manage the registration relationship model (e.g., a visual interface presenting the registration relationships as shown in FIG. 3).

In some embodiments, the first visual window and the second visual window may be displayed in a way, such as left and right layout, top and bottom layout, overlapping layout, or the like. In some embodiments, in any layout process, relative positions of the first visual window and the second visual window may be automatically adjusted or manually adjusted. by the user. In some embodiments, in response to the closing of the first visual window, the second visual window may be opened by the processing device 120. In some embodiments, in response to the open of the first visual window, the second visual window may be opened by the processing device 120. In some embodiments, in response to a selection of a user for one or more images displayed on the first visual window, the second visual window may be opened by the processing device 120.

In some embodiments, the user may perform a selection operation for the at least two of the multiple images, after the processing device 120 receives the selection operation, in response to the selection operation, the two images that have been selected may be displayed on the first visual window according to the selection operation; the second visual window may be opened, the registration relationship between the selected images may be displayed, and the displayed registration relationship may be managed through the second visual window.

In some embodiments, the visualizing registration relationship between two images may include displaying a registration mode and/or registration direction between the reference image and the floating image among the two images.

In some embodiments, the processing device 120 may display an image on the user interface by displaying an identifier of the image. The identifier of the image may be linked to a storage address. And if the identifier of the image is clicked by a user, the image may be called back and displayed via the first visual window. The identifier of an image may be denoted by the number of the image, an ID of the image, a description of the image, a name of the image, etc.

In some embodiments, the processing device 120 may highlight the reference image on a user interface. For example, the reference image may be highlighted in bold, different colors, or the like. As used herein, highlighting the reference image refers to highlighting an identifier of the reference image.

In some embodiments, the processing device 120 may present a registration relationship of at least two of the multiple images on the user interface by a line connecting the at least two of the multiple images. A characteristic of the line (e.g., a color, a type, a thickness) may represent a registration mode. For example, connecting lines with different thicknesses represent different registration modes. As another example, the type of a line may include a dotted line, a solid line, etc. A dotted line and a solid line may represent different registration modes. As still another example, different connecting lines with different colors represent different registration modes. The characteristic of the line may be adjusted according to an input of a user, such that the registration relationship between two images may be adjusted.

For example, as shown in FIG. 3, the images may be classified into three groups: the group 1, the group 2, and the group 3. The different images may be connected by registration connecting lines, indicating the registration mode and the registration direction of images. The reference image 1.3, the reference image 2.4, and the reference image 3.4 may be regard as the reference images and be highlighted in bold. In some embodiments, multiple types of connecting lines may depend on the types of the registration algorithms, and each of the registration algorithms may correspond to a type of connecting line. The registration modes in FIG. 3 may include a registration mode 1, a registration mode 2, and manual registration, and the three connecting lines may correspond to the three registration modes, respectively. In some embodiments, an arrow of the connecting line may point from a floating image to be registered to the reference image, indicating a registration from the floating image to the reference image.

As shown in FIG. 3, both image 1.1 and image 1.2 may be registered to image 1.3 by using registration mode 1 in group 1, the arrow pointing indicates that image 1.1 and image 1.2 may be floating images, and image 1.3 may be a reference image. Image 2.1, image 2.2, and image 2.3 may be registered to image 2.4 in the group 2 by using the registration mode 1, the arrow pointing indicates that image 2.1, image 2.2, and image 2.3 may be floating images, and image 2.4 may be a reference image. Image 3.1, image 3.2, image 3.3, and image 3.5 may be registered to image 3.4 in the group 3 by using the registration mode 1, the arrow pointing indicates that image 3.1, image 3.2, image 3.3, and image 3.5 may be the floating images, and image 3.4 may be a reference image. Image 2.4 may be registered to image 1.3 by using the registration mode 2, and image 3.4 may be manually registered to image 1.3, the arrow pointing indicates that image 2.4 and image 3.4 may be the floating images, and image 1.3 may be a reference medical image in the two registration relationships.

In some embodiments, the processing device 120 may open images of interest simultaneously based on a selection instruction inputted by a user (e.g., a doctor) on a browsing interface (i.e., the first visual window). The images of interest may be already registered and aligned with each other. In some embodiments, the user may browse the images of interest on the browsing interface and perform diagnostic and other operations based on the images. In some embodiments, the users may open the visual interface of the registration relationship (i.e., the second visual window) during a browsing process to adjust the registration relationship of the images of interest.

In some embodiments, the registration between a reference image and a floating image may include a coarse registration process (e.g., a first registration process or a third registration process) and a fine registration process e.g., a second registration process or a fourth registration process). The coarse registration process may be performed on the reference image and a floating image to obtain a coarse registration result (also referred to as an initial registration result). The fine registration process may be configured to optimize the initial registration result to obtain a final registration result (also referred to as a fine registration result).

In some embodiments, a registration result may include a coordinate transformation relationship between coordinate systems of the floating image and the reference image, and the coordinate transformation relationship may be configured to convert coordinates denoted by the coordinate system applied to the floating image to coordinates denoted by the coordinate system applied to the reference image. For example, the initial registration result may include an initial coordinate transformation relationship between the coordinate systems of the floating image and the reference image. As another example, the final registration result may include a final coordinate transformation relationship between the coordinate systems of the floating image and the reference image.

In some embodiments, a registration result may include a registered image of the floating image obtained by converting the floating image using the coordinate transformation relationship. For example, the initial registration result may include an initial registered image of the floating image obtained by converting the floating image using the coordinate transformation relationship. As another example, the final registration result may include a final registered image obtained by converting the floating image or the initial registered image by using the final coordinate transformation relationship.

In some embodiments, images in the same group may be registered based on the coarse registration process and the fine registration process.

In some embodiments, images in different groups may be registered based on the coarse registration and the fine registration.

In some embodiments, the registration relationships for a first group of images may indicate that first floating images in the first group of images may be registered to a first reference image in the first group of images; the registration relationships for a second group of images may indicate that second floating images in the second group of images may be registered to a second reference image in the second group of images; and a registration relationship between the first reference image and the second reference image may indicate that the second reference image is registered to the first reference image. In other words, the first group of images excepting the first reference image and the second group of images may be registered to the first reference image. The first reference image may be a target reference image.

The registration of the images in the first group and the second group into the first reference image may include registering the first floating images to the first reference image to obtain a first registration result and registering the second floating images to the second reference image to obtain a second registration result. The registration of the images in the first group and the second group into the first reference image may include registering the second reference image to the first reference image to obtain a third registration result. The registration of the images in the first group and the second group into the first reference image may further include updating the second registration result based on the third registration result to obtain a target registration result.

In some embodiments, the first registration result may include a coarse registration result or a fine registration result between each first floating image and the first reference image.

In some embodiments, the second registration result may include a coarse registration result or a fine registration result between each second floating image and the second reference image.

In some embodiments, the third registration result may include a coarse registration result or a fine registration result between the second reference image and the first reference image.

In some embodiments, the first registration result may include a coarse registration result between each first floating image and the first reference image, the second registration result may include a coarse registration result between each second floating image and the second reference image, and the third registration result may include a coarse registration result between the second reference image and the first reference image.

In some embodiments, the first registration result may include a fine registration result between each first floating image and the first reference image, the second registration result may include a fine registration result between each second floating image and the second reference image. And the third registration result may include a fine registration result between the second reference image and the first reference image.

In some embodiments, the first registration result may include a coarse registration result between each first floating image and the first reference image, the second registration result may include a fine registration result between each second floating image and the second reference image. And the third registration result may include a fine registration result between the second reference image and the first reference image.

In some embodiments, the coarse registration result between two images (e.g., the first floating image and the first reference image, the second floating image and the second reference image, the first reference image and the second reference image) may be obtained by performing a coarse registration process based on coordinate positions of the two images. Specifically, a coordinate from a coordinate system of the floating image to a coordinate system of the reference image among the two images may be obtained by using a third-party coordinate system. For example, a point in the floating image and a point in the reference image may correspond to the same point of a subject. Coordinates of the point in the floating image denoted by the coordinate system of the floating image may be converted to coordinates of the same point of the subject denoted by a coordinate system of the subject, and coordinates of the point in the reference image denoted by the coordinate system of the reference image may be converted to the same coordinates of the same point of the subject denoted by the coordinate system of the subject. Then the coarse registration result may be obtained based on the same coordinates of the same point of the subject denoted by the coordinate system of the subject. In some embodiments, the processing device 120 may designate the coarse registration result as a registration result in the same group by performing the coarse registration process in the same group. For example, the registration mode 1 in FIG. 3 may be an initial registration in the same group based on the coordinate positions of the reference image and the floating image in the same group.

In some embodiments, the fine registration may include at least one of a fine registration in the same group and a fine registration in different groups. In some embodiments, a fine registration may be performed based on a similarity degree between the reference image and the floating image and the result of the coarse registration to obtain a fine registration result. In some embodiments, the processing device 120 may designate the fine registration result as a target registration result by performing the coarse registration in the different groups. The target registration result represents a spatial transform relationship between the reference image and the floating image during a registration process. For example, the target registration result may include the coordinate transformation matrix, or the like.

For example, the registration mode 2 in FIG. 3 may be an initial registration between the different groups based on key points extracted from the reference image and the floating image and a registration result (e.g., a coarse registration result, or a fine registration result) in the same group, and/or a fine registration based on the similarity degree between the reference image and the floating image and the result of the coarse registration. More descriptions of the registration in the same group, the registration in the different groups, the coarse registration, and the fine registration may be found in FIG. 7 and related descriptions, which may not be limited herein.

In some embodiments, after the operation 230, the operation 240 may also be included. Based on the registration relationship displayed on the visual interface of the registration relationship, in response to the user operations on the visual interface of the registration relationship, the processing device 120 may perform the operation 240, and adjust the registration relationship between the multiple images based on the operations. That is, the registration relationship model.

In 240, a user operation inputted by a user may be obtained via the user interface, and the registration relationship model may be adjusted based on the user operation, i.e., the registration relationships of the multiple images. The adjustment of the registration relationship model includes at least one of modifying at least one of the multiple registration relationships; adding a registration relationship between two of the multiple images; deleting a registration relationship between two of the multiple images, or the like, or a combination thereof.

In some embodiments, based on the registration relationship model of the multiple images displayed on the user interface, the processing device 120 may obtain the user operation inputted by the user via the user interface, and adjust the registration relationship model of the images based on the user operation. In some embodiments, the user operation may include modifying the registration relationships, adding the registration relationships, deleting the registration relationships, or the like.

In some embodiments, the user operation may include clicking, long pressing, dragging, or the like. In some embodiments, the user operation may be achieved through various manners such as touch screen, mouse click, voice control, visual control, virtual reality (VR)/mixed reality (MR) or the like.

In some embodiments, modifying any registration relationship may include modifying at least one of the registration mode, the registration direction, or the reference image for registration.

In some embodiments, when the user modifies a registration mode between a reference image and a floating image from the original registration mode to a new registration mode, the processing device 120 may register the reference image and the floating image based on the new registration mode, and visually display the registration relationship between the reference image and the floating image with the new registration mode.

In some embodiments, in the user interface, the user may click on the connecting line between two images that represents a registration relationship between the two images; select the manner to be changed, wherein the change may be deleting or modifying the connection line. The modifying of the connection may include changing a specific registration mode, a registration direction, and a reference image for registration. The processing device 120 may perform the selected operation; finally, the processing device 120 may update the connecting line on the interface.

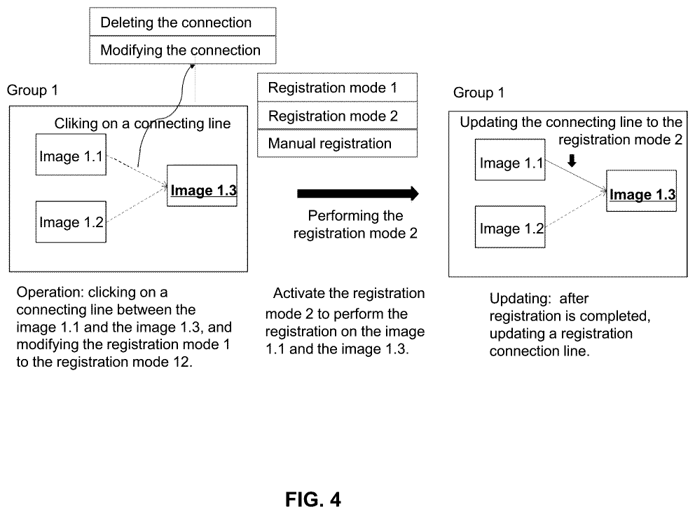

Merely for example, a visualization process for modifying the registration relationship model may be shown in FIG. 4. As shown in an image on the left side in FIG. 4, an original registration mode of a registration relationship between the image 1.1 and the image 1.3 may be the registration mode 1. The user may adjust or modify the registration mode 1. The user may perform the following operations: clicking on a connection line between the image 1.1 and the image 1.3 to modify the original registration mode 1 to the registration mode 2. After the user clicks on the connection line, an operational option may be provided on the user interface, and the operation option may include: deleting the connection, modifying the connection-the registration mode 1 (since the registration mode 1 is the current registration mode, the registration mode 1 is not optional), modifying the connection-the registration mode 2, and modifying the connection-manual registration. In FIG. 4, if the user selects “modifying the connection-the registration method 2,” the processing device 120 may perform the operation; activate the registration mode 2 and perform the registration on the image 1.1 and the image 1.3 according to the registration mode 2. The processing device 120 may automatically perform registration between the image 1.1 and the image 1.3 according to the registration mode 2. Then, the processing device 120 may update the user interface: after registration of the image 1.1 and the image 1.3 is completed, update a registration connection line between the image 1.1 and the image 1.3, that is, update the connection line between the image 1.1 and the image 1.3 on the user interface to a connection line corresponding to the registration mode 2, and obtain the registration relationship between the image 1.1 and the image 1.3 shown in the right side in FIG. 4. In some embodiments, the user may modify the registration direction and/or the reference image for registration of the image 1.1 in FIG. 4. For example, the user may adjust the registration direction of the image 1.1 to point to the image 1.2, that is, the image 1.2 may be designated as a new reference image and the image 1.1 may be registered to the image 1.2.

In some embodiments, when the user deletes the existing registration relationship between the reference image and the floating image, the processing device 120 may update the registration relationship between the reference image and the floating image, and visually display an updated registration relationship between the reference image and the floating image.

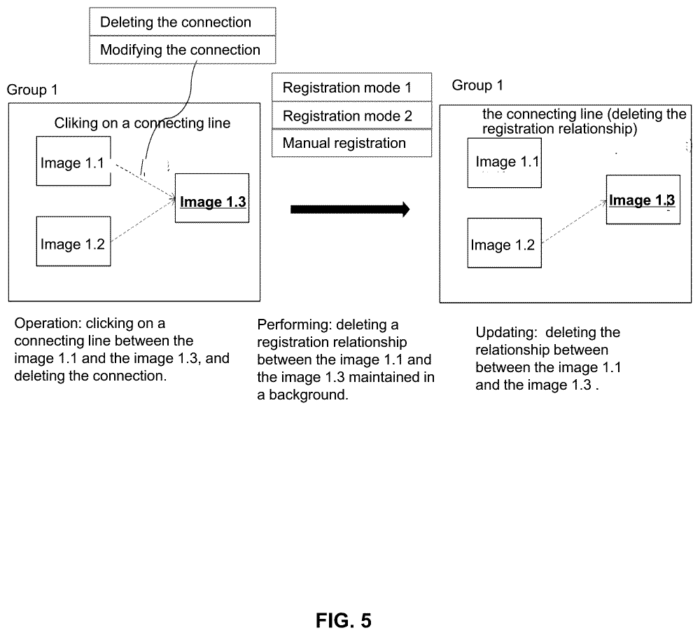

For example, a visualization process for deleting the registration relationship may be shown in FIG. 5, wherein the registration relationship shown in FIG. 5 may be based on the registration relationship in FIG. 3. As shown in an image on the left side in FIG. 5, there is a registration relationship between the current image 1.1 and the image 1.3. In response to receiving an operation from the user for deleting the registration relationship between the image 1.1 and the image 1.3, the following operations may be performed: clicking on a connection line between the image 1.1 and the image 1.3 to delete the connection. The user may click on the connection line, open the operational option, and select “deleting the connection.” The processing device 120 may update the user interface after the stored registration relationship between the image 1.1 and image 1.3 is deleted: delete the registration relationship between the image 1.1 and the image 1.3, that is, delete a connecting line between the image 1.1 and the image 1.3, and obtain the registration relationship shown in an image on the right side in FIG. 5.

In some embodiments, when the user adds the registration relationship between the reference image and the floating image, the processing device 120 may register the reference image and the floating image based on the selected registration mode, and visually display the registration relationship between the reference image and the floating image.

In some embodiments, in response to receiving an operation from the user for directly registering two unregistered images, a registration line may be added directly. The users may select any two images in the first visual window of the user interface; provide an adding option in the second visual window, wherein the option may include optional registration modes; the needed registration mode may be selected; the processing device 120 may perform the selected registration mode; after completing the registration, the processing device 120 may connect the two images using a corresponding connecting line.

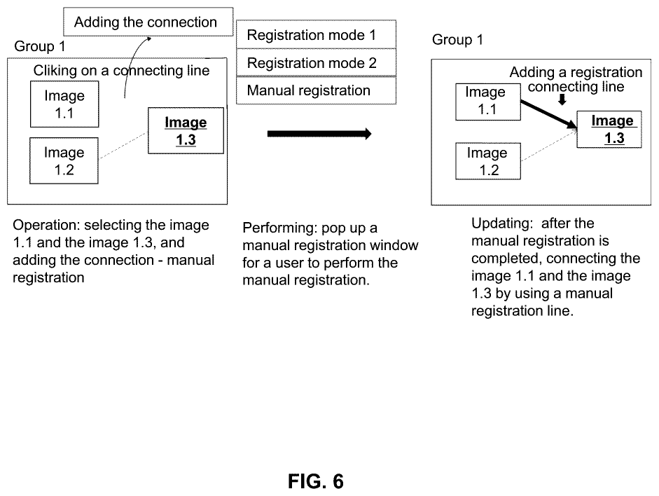

For example, a visualization process for adding the registration relationship may be shown in FIG. 6, wherein the registration relationship model shown in FIG. 6 may be based on the registration relationship model in an image on the right side in FIG. 5. As shown in an image on the left side in FIG. 6, there is not a registration relationship between the current image 1.1 and the image 1.3. In response to receiving an operation from the user for performing the registration between the image 1.1 and the image 1.3, the following operation may be performed: selecting the image 1.1 and the image 1.3, and adding the connection-manual registration. At this point, a manual registration window may pop up, and the user may perform the manual registration on the window interface. After the user completes the manual registration, the processing device may update the interface by connecting the image 1.1 and the image 1.3 with a manual registration connecting line, that is, adding a connection line between the image 1.1 and the image 1.3 on the interface.

In some embodiments, the processing device 120 may obtain a registration result between of at least two of the multiple images that is determined based on the registration relationship; in response to receipt of an adjusting operation of the user via the second visual window, the processing device 120 may adjust the registration result of the at least two of the multiple images. For example, as shown in FIG. 4, the processing device 120 may obtain a registration result between the image 1.1 and the image 1.3 using the registration mode 1, and after the user modifies the registration mode between the image 1.1 and the image 1.3 from the registration mode 1 to the registration mode 2, the processing device 120 may re-obtain the registration result between the image 1.1 and the image 1.3 using the registration mode 2.

In some embodiments of the present disclosure, by grouping a large number of images (e.g., different modalities, different times, different beds, etc.) based on the registration relationships and performing operations related to the registration directly based on a visual registration relationship diagram, the process may be clear and the operation is convenient, which facilitates management of registration relationships of large-scale images and solves problems of difficult image management caused by excessive registration times, resulting in improving the convenience of the user registration for the large-scale images and adjusting the registration relationships to meet the needs of different users, ensuring the diagnosis and treatment effectiveness of the users based on registered images; by visualizing the registration relationships and the operations related to the registration, human-machine interaction can be improved, user experience can be enhanced, user operations can be facilitated, learning costs can be reduced, and the users can quickly master registration operations.

FIG. 7 is a flowchart illustrating an exemplary process for fusing images according to some embodiments of the present disclosure.

As shown in FIG. 7, the process 700 may include the following operations. In some embodiments, the process 700 may be executed by the processing device 120. In some embodiments, the processing device 120 may implement the registration method described in process 200 by executing the operations shown in process 700.

In 710, multiple images may be obtained. An image may include a medical image, a visual image, an infrared image, a radar image, etc. Operation 710 may be similar to operation 210, which may not be repeated herein.

In 720, the multiple images may be classified into multiple groups.

Due to a potential large number of multiple images, various factors such as image quality, modality, as well as the varying focus on organs, it is difficult to register the multiple images. In some embodiments, the processing device 120 may classify the multiple images into multiple groups according to a rule. In some embodiments, the number of groups may be two or more.

In some embodiments, the rule may include a classification standard for classifying the multiple images into the multiple groups. The classification standard may be related to medical imaging devices for obtaining the multiple images, reference coordinate systems, a portion of a subject represented in each of the multiple images, one or more scanning parameters for acquiring each of the multiple images, or the like, or a combination thereof.

In some embodiments, the processing device 120 may classify the images based on the modality of a medical imaging device configured to acquire each of the images. The images in the same group may be acquired by a same modality of scanner. For example, images acquired by CT scanners may be classified into one group. As another example, images acquired by MRI scanners may be classified into one group.

In some embodiments, the processing device 120 may classify one or more images among the images into the same group based on whether the one or more images are acquired by the same imaging device. Images in the same group may be obtained by the same imaging device. For example, images obtained by a scanner 1 may be classified into one group, images obtained by a scanner 2 may be classified into another group, or the like.

In some embodiments, the processing device 120 may classify one or more images in the images based on whether the one or more images correspond to the same reference coordinate system. In some embodiments, the reference coordinate system may be applied to a scanning bed. The reference coordinate systems for different images may be different for different bed positions. For example, images acquired at a bed position 1 may be classified into one group, images acquired at a bed position 2 may be classified into another group, or the like. In some embodiments, the reference coordinate system may be applied to an imaging device. The reference coordinate systems for different images may be different for different imaging devices.

In some embodiments, the processing device 120 may classify the images based on the portion of the subject represented in each of the multiple images. Images in the same group may represent the same portion of a subject. For example, images of the head of a patient may be classified into one group, images of the liver of the patient may be classified into another group, or the like.

In some embodiments, the processing device 120 may classify the images based on one or more scanning parameters for acquiring each of the multiple images. Images in the same group may be acquired according to one or more same scanning parameters. For different imaging devices, the scanning parameters may be different. For example, scanning parameters for a CT scanner may include a scanning type (e.g., non-spiral scan, spiral scan), exposure conditions (e.g., tube voltage (kV), a tube current (mA), scanning time(s), etc.), a field of view (FOV), a reconstruction matrix, a slice thickness, a slice gap, a reconstruction interval, or the like. Scanning parameters for an MR scanner may include a repetition time (TR), an echo time (TE), a number of excitations (NEX), an acquisition time (TA), a field of view (FOV), a reconstruction matrix, a slice thickness, a slice gap, a deflection angle, or the like. The scanning parameters of the MR scanner may be defined by a scan pulse sequence. For example, images obtained according to a T1 scan sequence may be classified into one group, images obtained according to a DWI scan sequence may be classified into another group, or the like.

In some embodiments, the processing device 120 may classify the images based on multiple different classification standards. For example, images with the same modality of medical imaging devices and representing the same portion of a subject may be classified into one same group.

The difficulty of registering two images in the same group may be lower than the difficulty of registering two images in different groups as the images in the same group may have one or more commonalities, such as acquired by the same modality of imaging devices, representing the same portion of the subject, acquired according to one or more same scanning parameters, corresponding to the same reference coordinate system, etc.

In some embodiments of the present disclosure, by grouping the images based on the medical imaging devices, the reference coordinate systems, and the portion of the subject, a large and complex variety of multimodal and multi-field images may be classified according to commonality, making the images easy to manage; by classifying image data, images with low or high registration difficulty may be processed separately, and different registration modes may be used to reduce registration difficulty and increase the stability of registration quality. For example, images acquired by different medical devices may be with relatively higher registration difficulty while images acquired by the same devices may be with relatively lower registration difficulty; images acquired during different bed positions of scans may be with relatively higher registration difficulty while images acquired during the same bed position of scans may be with relatively lower registration difficulty; images acquired according to different scanning parameters may be with relatively higher registration difficulty while images acquired according to the same scanning parameter may be with relatively low difficult.

In 730, for each group of images, a first registration result may be obtained by registering multiple images in the same group.

The processing device 120 may obtain the first registration result by registering each floating image of the multiple images with a reference image in the same group. The first registration result may include multiple first registration sub-results each of which is obtained by registering a floating image of the multiple images with the reference image in the same group. In some embodiments, the first registration sub-result may include a coordinate transformation relationship between a coordinate system applied to the floating image and a coordinate system applied to the reference image in the same group.

The reference image refers to an image used as a registration reference. The reference image may be determined from the multiple images in the same group according to one or more scanning parameters of each of the multiple images in the same group, one or more evaluation parameters of each of the multiple images in the same group, etc. The scanning parameters may include a field of view (FOV), a time resolution, a spatial resolution, scan types (e.g., non-spiral scan, spiral scan), matrix, slice thickness, slice gap, repetition time (TR), echo time (TE), number of excitation (NEX), acquisition time (TA), or the like. For example, the processing device 120 may determine one of the multiple images in the same group with a maximum field of view as the reference image corresponding to the same group. As another example, the processing device 120 may determine one of the multiple images in the same group with a maximum spatial resolution as the reference image corresponding to the same group. The one or more evaluation parameters may include an image noise level, an image contrast, a signal-to-noise ratio (SNR) of an image, an artifact level of an image, an image resolution, etc. For example, the processing device 120 may determine one of the multiple images in the same group with a maximum image contrast as the reference image corresponding to the same group. As another example, the processing device 120 may determine one of the multiple images in the same group with a minimum noise level or an artifact level as the reference image corresponding to the same group.

In some embodiments, the processing device 120 may determine one of the multiple images in the same group as the reference image corresponding to the same group according to a user input or a default setting of the system 100 as a reference image.

In some embodiments, the first registration sub-result between a floating image and the reference image may be obtained according to a first registration process (also known as a coarse registration, an initial registration) and/or a second registration process (also known as a fine registration, a precise registration). The first registration process may be performed based on position information in a floating image and the reference image (e.g., a coordinate position of pixels in a floating image and the reference image) and a second registration process may be performed based on gray-level information in the floating image and the reference image.

In some embodiments, according to the first registration process between the floating image and the reference image in the same group, the processing device 120 may determine a first transformation relationship between a first coordinate system applied to the floating image and a reference coordinate system applied to a subject. The processing device 120 may also determine a second transformation relationship between a second coordinate system applied to the reference image and the reference coordinate system applied to the subject. The processing device 120 may further determine an initial transformation relationship between the first coordinate system and the second coordinate system based on the first transformation relationship and the second transformation relationship.

In some embodiments, the initial coordinate transformation relationship may include an initial transformation matrix, which is a spatial coordinate transformation matrix between the reference image and the floating image.

As described above, the processing device 120 may perform the first registration process based on coordinate positions of the reference mage and the floating image in the same group. Taking the preset rule including classifying images corresponding to the same reference coordinate system (i.e., the same bed) into the same group as an example, images in the same group may correspond to the same reference coordinate system. In some embodiments, the first registration process may be performed based on the same reference coordinate system.

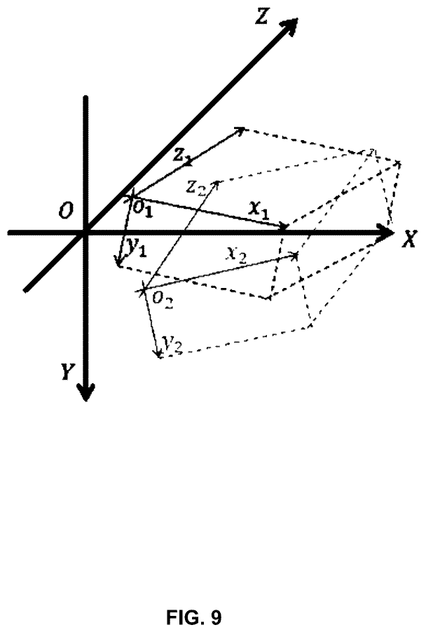

As shown in FIG. 9, OXYZ represents a reference coordinate system of a patient, o₁x₁y₁z₁ represents a coordinate system (e.g., the first coordinate system) of a first image (e.g., a floating image) representing a subject acquired by a scanner, o₂x₂y₂z₂ represents a coordinate system (e.g., the second coordinate system) of a second image (e.g., the second reference image) representing the subject acquired by the same scanner. A portion of the subject may be represented in the first image as V1. The portion of the subject may be represented in the second image as V2. A position of V1 may be denoted by the coordinate system applied to the first image and the position of V2 may be denoted by the coordinate system applied to the second image. Due to being scanned by the same device, the portion of the subject represented in the first image and the second image may not only correspond to the own coordinate system, but also correspond to a relatively large coordinate system OXYZ of the patient. Therefore, a point P in OXYZ may be denoted as a point P1 in the system o₁x₁y₁z₁ and a point P2 in the system o₂x₂y₂z₂, and positions of P1 and P2 may be correlated by using the coordinate system OXYZ. In some embodiments, if M1 is a coordinate transformation matrix that converts coordinates in the coordinate system o₁x₁y₁z₁ to coordinates in the OXYZ coordinate system (i.e., the first transformation relationship), M2 is a coordinate transformation matrix that converts coordinates in the coordinate system o₂x₂y₂z₂ to coordinates in the OXYZ coordinate system (i.e., the second transformation relationship), a correlation formula of P1 and P2 may be shown as follow:

$${M}_{1} {P}_{1} = {M}_{2} {P}_{2} ⇒ {M}_{2}^{- 1} {M}_{1} {P}_{1} = {P}_{2} , \qquad ( 1 )$$

$$wherein {M}_{1} = [ \begin{matrix}{R}_{1} & {o}_{1} \\ 0 & 1\end{matrix} ] , {R}_{1} = [ {o}_{1} {x}_{1} ; {o}_{1} {y}_{1} ; {o}_{1} {z}_{1} ] , and \\ {M}_{2} = [ \begin{matrix}{R}_{2} & {o}_{2} \\ 0 & 1\end{matrix} ] , {R}_{2} = [ {o}_{2} {x}_{2} ; {o}_{2} {y}_{2} ; {o}_{2} {z}_{2} ] ;$$

o₁x₁, o₁y₁, and o₁z₁ represent direction vectors of the x-axis, the y-axis, and the z-axis of the coordinate system o₁x₁y₁z₁ in the coordinate system OXYZ, and o₂x₂, o₂y₂, and o₂z₂ represent direction vectors of the x-axis, the y-axis, and the z-axis of the coordinate system o₂x₂y₂z₂ in the coordinate system OXYZ. The direction vectors of the x-axis, the y-axis, and the z-axis of the coordinate system o₁x₁y₁z₁ in the coordinate system OXYZ, and the direction vectors of the x-axis, the y-axis, and the z-axis of the coordinate system o₂x₂y₂z₂ in the coordinate system OXYZ may be a default setting of the system.

In some embodiments, based on the formula (1), the initial coordinate transformation relationship (i.e., the initial transformation relationship) between positions V1 and V2 may be shown as follow:

$${T}_{0} = {M}_{2}^{- 1} {M}_{1} \qquad ( 2 )$$

where T₀ represents a coordinate transformation matrix between the coordinate system o₁x₁y₁z₁ where V1 is located and the coordinate system o₂x₂y₂z₂ wherein V2 is located.

In some embodiments, after the first registration process, an accuracy of the obtained registration result may not meet requirements, and the second registration process may be further performed, i.e., a fine registration process. For example, a user may determine whether the initial transformation relationship satisfies requirements. As another example, the processing device 120 may determine whether the initial transformation relationship satisfies a requirement by registering a test image with a test reference image to obtain a registered test image using the initial transformation relationship. The processing device 120 may determine a similarity between the registered image and the test reference image. If the similarity between the registered image and the test reference image exceeds a threshold (e.g., 90%), the processing device 120 may determine that the initial transformation relationship satisfies a requirement. The threshold may be a default setting of the system or determined or adjusted by a user according to actual needs. In some embodiments, the processing device 120 may optimize the initial transformation relationship by using a registration algorithm (e.g., a grayscale-based registration algorithm), which can theoretically achieve a sub-pixel level registration accuracy.

In some embodiments, on the basis of the first registration process, the processing device 120 may perform the second registration process in the same group.

In some embodiments, for the registration in the same group, after obtaining the initial transformation relationship, the processing device 120 may perform the second registration process based on various manners such as the similarity degree s to obtain the first registration sub-result.

In some embodiments, the second registration process may include multiple iterations. In a current iteration, the processing device 120 may determine a transformed image by performing an image transform on the floating image (i.e., floating images) based on an intermediate transformation relationship; determine a similarity degree in the grey-level information between the transformed image and the reference image; determine whether the similarity degree satisfies a condition; in response to determining that the similarity degree does not satisfy the condition, update the intermediate transformation relationship such that the similarity degree determined based on the updated intermediate transformation relationship satisfies the condition; and designate the updated intermediate transformation relationship as the intermediate transformation relationship used in the next iteration. The iteration process may be terminated until a termination condition is satisfied. The updated intermediate transformation relationship in the last iteration may be designated as a target coordinate transformation relationship between the first coordinate system and the second coordinate system (i.e., the first registration sub-result). The termination condition may include the number of iterations reaching a preset value (e.g., 5, 10, 20, etc.), the similarity degree being greater than or equal to a threshold (e.g., 0.95, 0.99, etc.), a difference of the similarity degree between the two iterations being less than a threshold (e.g., 0.01, 0.005, etc.), or any combination thereof. In some embodiments, the intermediate coordinate transformation relationship in the first iteration may be the initial coordinate transformation relationship determined according to the first registration process.

Merely for example, for images I₁ (e.g., the reference image) and I₂ (i.e., the floating image), the transformation matrix of the initial coordinate transformation relationship is T₀, the transformation matrix of the target coordinate transform relationship is T₁, I(T*T₀) represents performing a spatial transform on an image I by using the coordinate transformation matrix T*T₀ (i.e., the multiplication between the intermediate coordinate transformation matrix generated in each iteration and the initial coordinate transformation matrix), S represents a similarity degree between the reference image and a transformed image of the floating image based on a transformation matrix T*T₀, and an optimization process (i.e., the second registration process) may be shown as the following formula:

$${T}_{1} = {argmin}_{T} S ( {I}_{1} , {I}_{2} ( T * {T}_{0} ) \qquad ( 3 )$$

where argmin f(x) represents a variable value when minimizing an objective function f(x); S(I₁,I₂(T*T₀) is used to obtain a similarity degree between the floating image and a transformed image by transferring the reference image using coordinate transformation matrix T*T₀. The optimization process is to solve an optimal T (i.e., T₁), which makes the similarity degree between the images I₁ and I₂ meet the requirements, for example, when the similarity degree is the best, I₁ and I₂ may achieve the most similarity. In the optimization process, an intermediate coordinate transformation matrix T may be generated in each iteration. The intermediate coordinate transformation matrix T may be multiplied with the initial coordinate transformation matrix T₀ to obtain a coordinate transformation matrix. The coordinate transformation matrix may be used to convert the floating image I₂ to obtain a transformed image. The transformed image may be compared with the reference image to determine the similarity degree between the transformed image and the reference image. The intermediate coordinate transformation matrix T may be updated to increase the similarity degree until the termination condition is satisfied. The final registration relationship may be determined based on the optimal solution T₁ and the initial coordinate transformation matrix generated in the first registration process. For example, the final registration relationship may include a final coordinate transformation matrix determined according to formula (4) as follows:

$${T}_{final} = {T}_{1} * {T}_{0} . \qquad ( 4 )$$

In some embodiments, the processing device 120 may designate the initial first transformation relationship between the first coordinate system and the second coordinate system as a first registration sub-result, i.e., only the first registration process may be performed in the same group. In some embodiments, the processing device 120 may only perform the second registration process between a floating image and the first reference image to obtain the first registration sub-result. For example, the intermediate coordinate transformation relationship in the first iteration may be a default setting of the system 100 or set by a user manually.

In 740, for different groups of images, a second registration result may be obtained by registering multiple images each of which belongs to one of the different groups of images.

In some embodiments, the processing device 120 may obtain a target reference image.

In some embodiments, the processing device 120 may select one of the reference images as the target reference image based on a preset rule (e.g., suitability for registration, user preference, etc.). For example, the target reference image may be determined from the multiple reference images according to one or more scanning parameters of each of the reference images, one or more evaluation parameters of each of the reference images, etc. The scanning parameters may include a field of view (FOV), a time resolution, a spatial resolution, scan types (e.g., non-spiral scan, spiral scan), matrix, slice thickness, slice gap, repetition time (TR), echo time (TE), number of excitation (NEX), acquisition time (TA), or the like. For example, the processing device 120 may determine one of the reference images with a maximum field of view as the target reference image. As another example, the processing device 120 may determine one of the reference images with a maximum spatial resolution as the target reference image. The one or more evaluation parameters may include an image noise level, an image contrast, a signal-to-noise ratio (SNR) of an image, an artifact level of an image, an image resolution, etc. For example, the processing device 120 may determine one of the reference images with a maximum image contrast as the target reference image. As another example, the processing device 120 may determine one of the reference images with a minimum noise level or an artifact level as the target reference image. In some embodiments, the target reference image may be determined according to a default setting of the system 100 or set by a user manually.

The reference images may include the target reference image and floating images.

The processing device 120 may register the floating images among the reference images with the target reference image to obtain the second registration result. The second registration result may include multiple second registration sub-results. Each of the multiple second registration sub-results may be determined by registering a floating image in the reference images to the target reference image.

Accordingly, the processing device 120 may determine the target reference image from the multiple reference images in different groups; and register the remaining reference images with the target reference image to obtain the second registration result.

In some embodiments, a second registration sub-result may include a coordinate transformation relationship between the two coordinate systems of a floating image in the reference images and the target reference image. In some embodiments, the second registration sub-result may include a registered image after the floating image in the reference images is registered to the target reference image.

In some embodiments, the processing device 120 may obtain a second registration sub-result between a floating image in the reference images and the target reference image by performing a third registration process and/or a fourth registration process.

In some embodiments, the processing device 120 may perform the third registration process between the floating image in the reference images and the target reference image. based on feature position information (i.e., key position information) of key features in thee floating image in the reference images and the target reference image. The feature position information may include feature information related to the position of images, such as boxes, lines, points, or the like. The following description in the present disclosure may take the feature information position as an example for illustration.

In some embodiments, according to the third registration process, the processing device 120 may extract key features (e.g., center points of an eyeball, boundary points of brain tissue, etc.) from the floating image in the reference images and the target reference image by using a feature extraction model. Specifically, the floating image in the reference images and the target reference image may be input into the feature extraction model to obtain the feature position information (e.g., a key point coordinate, etc.) of the key features of each of the floating image in the reference images and the target reference image output by the feature extraction model. In some embodiments, the floating image in the reference images and the target reference image may be processed before inputted into the feature extraction model. The pre-processing may include various preprocessing operations such as noise reduction. In some embodiments, the images that are inputted into the key feature extraction model may include various types, such as at least one of a plain CT image, an enhanced CT image, a bone CT image, a soft tissue CT image, an MR T1 image, an MR T2 image, an MR Flair image, etc. A single feature extraction model can adapt to all image types, which can solve the complex processing problem caused by diverse data types.

In some embodiments, the feature extraction model may include various deep learning models, such as a convolutional neural network (CNN), a deep neural network (DNN), a recurrent neural network (RNN), or the like.

In some embodiments, the feature extraction model may be pre-trained. Training sample data may consist of various types of sample images, as well as key feature label data labeled for each of the sample images. The sample images may be input into a preliminary feature extraction model to obtain the key features of each sample image output by the preliminary feature extraction model. Based on a difference between the output key features and the key feature label data, the preliminary feature extraction model may be cyclically adjusted to obtain a trained feature extraction model.

In some embodiments, the processing device 120 may perform the third registration process based on the position information of key features. Specifically, the position information of the extracted key features of the floating image in the reference images may be matched with the position information of the key features of the target reference image, thereby obtaining an initial second registration sub-result. The initial second registration sub-result may include the initial transformation relationship between the coordinate system of the floating image in the reference images and the coordinate system of the target reference image.

For example, according to the third registration process, for the floating image in the reference images and the target reference image), the processing device 120 may determine one or more reference points from each of the floating images in the reference images and the target reference image; match the one or more reference points determined from the floating image in the reference images and the one or more reference points determined from the target reference image to obtain corresponding reference points in the floating image in the reference images and the target reference image; determine an initial second transformation relationship between a first coordinate system and a second coordinate system applied to the floating image in the reference images and the target reference image, respectively, based on the corresponding reference points. In some embodiments, the processing device 120 may designate the initial second transformation relationship between the first coordinate system of the floating image in the first reference images and the second coordinate system of the target reference image as the second registration sub-result, i.e., only performing the first registration process on the floating image in the reference images and the target reference image. As used herein, matching two reference points in the floating image in the reference images and the target reference image refers to determining the two reference points that correspond to the same portion or position on the subject represented in the floating image in the reference images and the target reference image.

Taking two images 1 and 2 as examples to illustrate matching of the key feature position information, assuming that a point set extracted from the image 1 is S₁={q₁,q₂, . . . ,qₘ}, and a point set extracted from the image 2 is S₂={q₁′,q₂′, . . . ,qₙ′}. Due to differences in a field of view (e.g., one containing the head and the other not), different scanning times, different modalities, or other reasons, the points contained in S₁ and S₂ may be different, the points other than common points in S₁ and S₂ may be deleted and the common points in S₁ and S₂ may be retained, wherein the common points represent same body positions of the scanning object (e.g., both the points are center points of the left eye, etc.). Assuming that S₁ and S₂ include k(k<=min(m,n)) common points, i.e., q₁,q₂, . . . ,qₖ and q₁′,q₂′, . . . ,qₖ′, the remaining points may be q₁,q₂, . . . , qₖ and q₁′,q₂′, . . . ,qₖ′. In some embodiments, parameters for solving registration relationships of points (i.e., a coordinate transformation matrix of two different coordinate systems sharing a common point) may include translation parameters, rotation parameters, misalignment parameters, or the like. The registration relationship may be denoted as T₀′ (i.e., the initial transformation relationship in the third registration process), T₀′ may be determined by the following formula:

$${T}_{0}^{′} {Q}_{1} = {Q}_{2} ⇒ {T}_{0}^{′} = {Q}_{2} {Q}_{1}^{- 1} , \qquad ( 5 )$$

$$wherein {Q}_{1} = \vert \begin{matrix}{x}_{1} & {x}_{2} & … & {x}_{k} \\ {y}_{1} & {y}_{2} & … & {y}_{k} \\ {z}_{1} & {z}_{2} & … & {z}_{k}\end{matrix} \vert , {Q}_{2} = \vert \begin{matrix}{x}_{1}^{′} & {x}_{2}^{′} & … & {x}_{k}^{′} \\ {y}_{1}^{′} & {y}_{2}^{′} & … & {y}_{k}^{′} \\ {z}_{1}^{′} & {z}_{2}^{′} & … & {z}_{k}^{′}\end{matrix} \vert ( {x}_{i} , {y}_{i} , {z}_{i} )$$

may be coordinates of the points q₁,q₂, . . . ,qₖ in S₁, (xᵢ′,yᵢ′,zᵢ′) may be coordinates of the points q₁′,q_{2′}, . . . ,qₖ′ in S₂, i represents a numeric index, 1<=i<=k.

In some embodiments, the image to be registered may be multiplied by the initial second transformation relationship (i.e., the registration matrix or coordinate transformation matrix), that is, the coordinates of each point in the image to be registered may be multiplied by the registration matrix (e.g., T₀′) to perform the coordinate transform and obtain a corresponding image after the third registration process.

In some embodiments of the present disclosure, the registration mode based on deep learning for key feature localization can process difficult registration scenarios such as heterogeneous machines, multimodality, and large differences in the field of view, which has good adaptability, improves registration quality, and increases registration stability.

In some embodiments, the processing device 120 may perform the fourth registration process based on various manners, such as the similarity degrees to obtain the fourth registration result.

In some embodiments, the fourth registration process may include multiple iterations. In a current iteration, the processing device 120 may determine a transformed image by performing an image transform on the floating image (i.e., floating images) based on an intermediate transformation relationship; determine a similarity degree in the grey-level information between the floating image in the reference images and the target reference image; determine whether the similarity degree satisfies a condition; in response to determining that the similarity degree does not satisfy the condition, update the intermediate transformation relationship such that the similarity degree determined based on the updated intermediate transformation relationship satisfies the condition; and designate the updated intermediate transformation relationship as the intermediate transformation relationship used in the next iteration. The iteration process may be terminated until a termination condition is satisfied. The updated intermediate transformation relationship in the last iteration may be designated as a target coordinate transformation relationship between the first coordinate system of the floating image in the reference images and the second coordinate system of the target reference image (i.e., the second registration sub-result). The termination condition may include the number of iterations reaching a preset value (e.g., 5, 10, 20, etc.), the similarity degree being greater than or equal to a threshold (e.g., 0.95, 0.99, etc.), a difference of the similarity degree between the two iterations being less than a threshold (e.g., 0.01, 0.005, etc.), or any combination thereof. In some embodiments, the intermediate coordinate transformation relationship in the first iteration may be the initial second coordinate transformation relationship determined according to the third registration process. The processing device 120 may perform the fourth registration relationship between the floating image in the reference images and the target image according to formula (4).

In some embodiments, the processing device 120 may designate the initial second transformation relationship between the first coordinate system and the second coordinate system as a second registration sub-result, i.e., only the third registration process may be performed.

In some embodiments, the processing device 120 may only perform the fourth registration process between a floating image in the first reference images and the second reference image to obtain the second registration sub-result. For example, the intermediate coordinate transformation relationship in the first iteration may be a default setting of the system 100 or set by a user manually.

In some embodiments, after obtaining the multiple images, i.e., operation 710, the processing device 120 may obtain the first registration result based on the position information of the multiple images rather than classify the multiple images, i.e., not perform the operation 720; and obtain a second registration result based on gray-level information of the multiple images and the first registration result. The operation of obtaining the first registration result and the second registration result may be similar to the operations 730 and 740. In some embodiments, the processing device 120 may select the reference image from the images, and designate the remaining images as the floating images, perform the first registration process or the third registration on the floating image and the reference image based on position information of the images, designate the initial transformation relationship between the first coordinate system applied to the floating images and the second coordinate system applied to the reference image as the first registration result; register the floating images with the reference image by the second registration process performed based on gray-level information of the images and the initial coordinate system, and designate the target transformation relationship between the first coordinate system and the second coordinate system as the second registration result.

In 750, the multiple images may be fused based on the first registration result and the second registration result.

In some embodiments, after obtaining the first registration result and the second registration result, the processing device 120 may fuse the floating images with the target reference image based on the first registration result and the second registration result.

In some embodiments, the processing device may determine a target registration result based on the first registration result and the second registration result. The target registration result may include multiple target sub-results. A target registration sub-result represents a spatial transformation relationship during a registration process of the floating image and the target reference image. The target registration sub-result may be denoted as T_{final}, the first registration sub-result may be denoted as Tᵢₙₜₑᵣ₁, and the second registration sub-result may be denoted as Tᵢₙₜₑᵣ₂, the target registration sub-result may be calculated by the following formula:

$${T}_{final} = {T}_{inter 1} * {T}_{inter 2} . \qquad ( 6 )$$

In some embodiments, the processing device 120 may register the specific image to the second reference image based on the target registration sub-result to obtain a floating image corresponding to the specific image. Specifically, the specific image may be multiplied by the target registration sub-result, that is, a coordinate of each point in the specific image to be registered may be multiplied by the registration matrix corresponding to the target registration sub-result, and the coordinate transform may be performed to obtain the registered image corresponding to the specific image to be registered.

In some embodiments, for the first reference image in a group, the fusion module 240 may determine a target registration sub-result based on a second registration sub-result corresponding to the first reference image. The second registration sub-result corresponding to the first reference image may be designated as the target registration sub-result.

In some embodiments, the processing device 120 may fuse the registered specific image with the second reference image to obtain a fused image.

In some embodiments, after the image fusion, i.e., after the operation 750, the processing device 120 may display the fused image to be registered and the reference image. When the user is not satisfied with a registration result of the fused image to be registered and the reference image, the manual registration may be performed on the image to be registered. Specifically, the user may browse or compare any one or more images from the reference image, the floating image, the image to be registered, the image after registration, and the image after fusion with the reference image. If the user is not satisfied with any one of the registered or fused images, the floating images may be adjusted manually and the manual registration may be performed until the user obtains satisfactory result.

In some embodiments, by classifying the image data and performing coarse and fine registrations on the grouped data, the images with relatively low and high registration difficulties may be processed separately and different registration modes may be used to effectively manage a large number of image data with varying registration difficulties, multimodality, and multiple field ranges. At the same time, the registration difficulty can be reduced, the registration effect can be improved and ensured, the stability of registration quality can be increased, and the diagnosis and treatment effectiveness can be ensured effectively based on the registered images. Through a fully automated registration process, the registration of complex registration scenarios such as heterogeneous, multimodal, large differences in the field of view, large differences in image quality, and a large number of images has been achieved, without the need for user participation, which greatly reduces user burden, reduces human resource consumption, reduces registration time, and eliminates human interference, thereby ensuring the quality and stability of registration and improving registration effectiveness. By manually adjusting the registration result based on automatic registration, the flexibility of registration can be improved, meeting the diverse needs of the users.

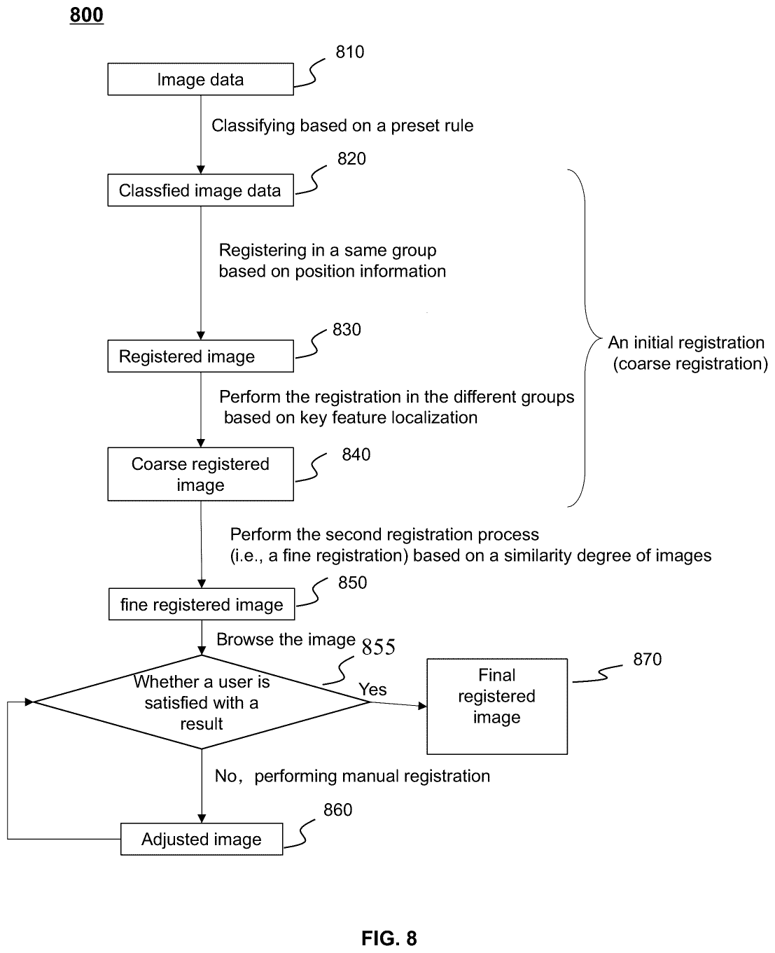

FIG. 8 is a schematic diagram illustrating an exemplary process for fusing images according to some embodiments of the present disclosure. In some embodiments, the process 800 shown in FIG. 8 may be performed by the processing device 120.

As shown in FIG. 8, in some embodiments, the processing device 120 may obtain and load image data 810. The image data 810 may include image data from at least one examination of the same patient. The processing device 120 may classify the image data 810 based on a preset rule to obtain classified image data 820. The preset rule for classifying may include at least one of a medical imaging device, a reference coordinate system, a portion of a subject, or the like. More descriptions of obtaining the image and classifying the image may be found in operation 720 and related descriptions, which may not be repeated herein.

In some embodiments, for the classified image data 820, the processing device 120 may perform a first registration process (e.g., the coarse registration) to obtain a coarse registration image 840. The first registration process may include a first registration process in the same group and a first registration process in different groups. In some embodiments, for each group of image data in the classified image data 820, the processing device 120 may perform the registration in the same group based on position information to obtain registration relationships and registered images 830 in the same group. On the basis of the registered images 830 in the same group, the processing device 120 may perform the registration in the different groups based on key feature localization to obtain a first registration result (e.g., an initial transformation matrix) and a coarse registered image 840. More descriptions of performing the first registration process based on the position relationship and the key feature localization may be found in operations 730 and 740 and related descriptions, which may not be repeated herein.

In some embodiments, for the coarse registered image 840, the processing device 120 may perform the second registration process (i.e., a fine registration) based on a similarity degree of the images to obtain a second registration result (e.g., a target transformation matrix) and a fine registered image 850. More descriptions of performing the fine registration based on the similarity degree of the images may be found in operation 730 and related descriptions, which may not be repeated herein.

In some embodiments, after the fine registered image 850 is obtained, the user may select any image for comparison, fusion, and browsing, and determine whether the user is satisfied with a result of the operation 855. In response if the user is not satisfied with the result, a manual registration may be performed on the current registered image to obtain an adjusted image 860, and the operations such as comparing, fusing, and browsing the images again may be performed to perform the operation 855 again and determine whether the user is satisfied with the result. In response the user is satisfied with the result, the current registered image may be designated as a final registered image 870 and the registration may be ended.

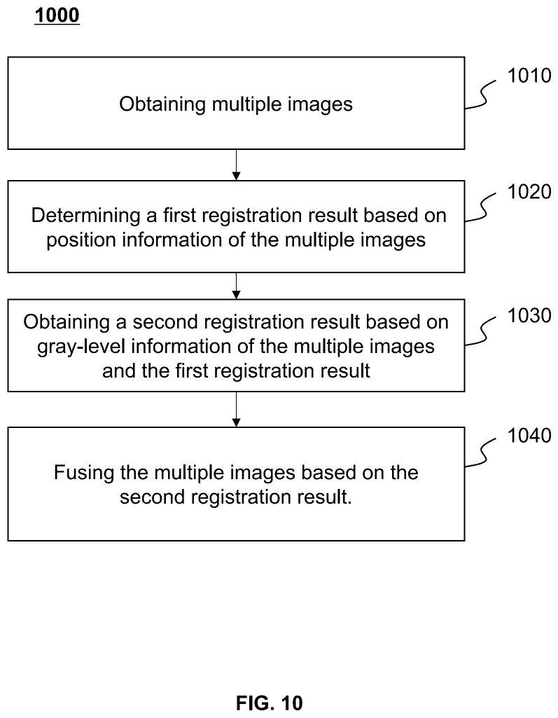

FIG. 10 is a flowchart illustrating an exemplary process for fusing images according to some embodiments of the present disclosure.

As shown in FIG. 10, process 1000 may include the following operations. In some embodiments, process 1000 may be executed by the processing device 120. In some embodiments, the processing device 120 may implement the registration method described in process 900 by executing the operations shown in process 1000.

In 1010, multiple images may be obtained. More descriptions for the multiple images may be found in operation 710 as illustrated in FIG. 7.

In 1020, a first registration result may be determined.

In some embodiments, the first registration result may be determined based on position information of the multiple images. In some embodiments, the first registration result may be determined using a transform domain-based registration algorithm, such as a phase transform algorithm, a Walsh transform algorithm, etc. In some embodiments, the first registration result determined based on the position information of the multiple images may include using an image feature-based registration algorithm. Using the image feature-based registration algorithm, a floating image of the multiple images and a reference image may be registered based on key features (e.g., key points or feature points, edges, closed regions, etc.,) extracted from the reference image and the floating image.

In some embodiments, the processing device 120 may obtain the first registration result by registering each floating image of the multiple images with a reference image in the multiple images. The first registration result may include multiple first registration sub-results each of which is obtained by registering a floating image of the multiple images with the reference image. In some embodiments, the first registration sub-result may include a first coordinate transformation relationship between a coordinate system applied to the floating image and a coordinate system applied to the reference image.

In some embodiments, the first registration sub-result between a floating image and the reference image may be obtained according to a coarse registration process. The coarse registration process may be performed based on position information in a floating image and the reference image. For example, the first registration sub-result between the floating image and the reference image may be obtained according to the first registration process as described in FIG. 7. As another example, the first registration sub-result between the floating image and the reference image may be obtained according to the third registration process as described in FIG. 7.

In some embodiments, the first coordinate transformation relationship may include a first transformation matrix, which is a spatial coordinate transformation matrix between the reference image and the floating image.

In 1030, a second registration result may be obtained.

In some embodiments, the second registration result may be determined based on gray-level information of the multiple images and the first registration result. In some embodiments, the second registration result may be determined using a transform domain-based registration algorithm, such as a phase transform algorithm, a Walsh transform algorithm, etc. In some embodiments, the second registration result determined based on the gray-level information of the multiple images may include using a mean absolute difference (MAD) registration algorithm, a sum of absolute error (SAD) registration algorithm, etc. The registration technique for the second registration result may be different from the registration technique for the first registration result.

The second registration result may include multiple second registration sub-results each of which corresponds to a floating image of the multiple images and the reference image. In some embodiments, the second registration sub-result may include a second coordinate transformation relationship between the coordinate system applied to the floating image and a coordinate system applied to the reference image.

In some embodiments, the second registration sub-result between a floating image and the reference image may be obtained according to a fine registration process. For example, the second registration sub-result between the floating image and the reference image may be obtained according to the second registration process as described in FIG. 7. As another example, the second registration sub-result between the floating image and the reference image may be obtained according to the fourth registration process as described in FIG. 7.

In 1040, the multiple images may be fused based on the second registration result. In some embodiments, each of the floating images may be transformed using the second coordinate transformation relationship between the floating image and the reference image to obtain a transformed image. The transformed images corresponding to floating images and the reference images may be fused.

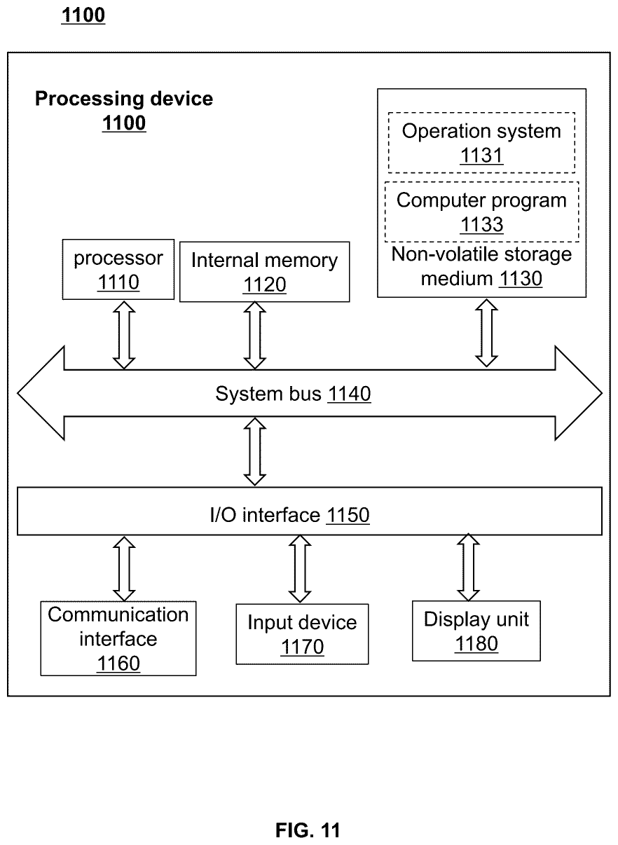

FIG. 11 is a schematic diagram illustrating an exemplary processing device of a system for image registration according to some embodiments of the present disclosure. In some embodiments, the system 1100 may include a processing device 1100.

As shown in FIG. 11, the processing device 1100 may include a processor 1110 connected through a system bus 1140, a memory (including an internal memory 1120 and a non-volatile storage medium 1130), a communication interface 1150, an input device 1170 and a display unit 1180. The communication interface 1150, the input device 1170, and the display unit 1180 may be connected to the system bus 1140 through the I/O interface 1150.

The processor 1110 may be configured to provide computing and control capabilities. In some embodiments, the processor 1110 may perform the registration on images as described in some embodiments of the present disclosure by executing computer instructions (e.g., a computer program 1133) in the memory. The non-volatile storage medium 1130 may store an operation system 1131 and a computer program 1133. The internal memory 1120 may provide an operation environment for the operation system 1131 and the computer program 1133 in the non-volatile storage medium 1130.

The communication interface 1150 may be configured for a wired or wireless communication with an external terminal (e.g., the operation terminal 120, the medical imaging device 130, and the storage device 140). The display unit 1180 may be configured to display various types of information such as an interactive interface with a user. The display unit 1180 may include various types of display screens, for example, a liquid crystal display screen, an e-ink display screen, a VR display device, or the like. The input device 1170 may be configured for a user input, and may include various input devices, for example, keys integrated in the device itself, a trackball or a touch pad, or the like, a touch layer covered on the touch screen, an external keyboard, a touch pad or a mouse, or the like.

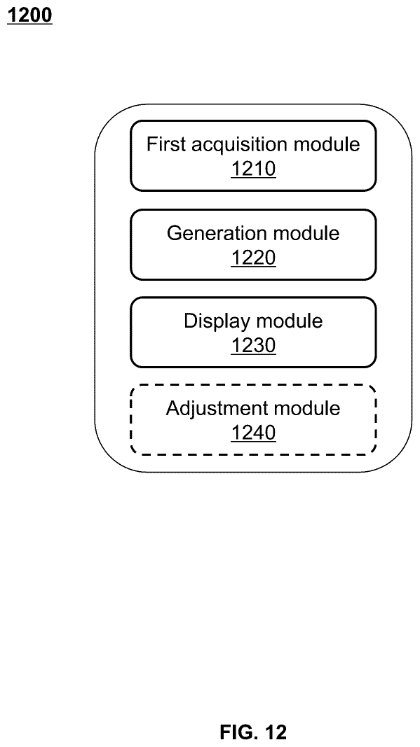

FIG. 12 is a schematic diagram illustrating an exemplary module of a system for image registration according to some embodiments of the present disclosure.

As shown in FIG. 12, the system 1200 for image registration may include a first acquisition module 1210, a generation module 1220, and a display module 1230. In some embodiments, the modules of the system 1200 for image registration may be implemented by the processing device 120.

In some embodiments, the first acquisition module 1210 may be configured to obtain multiple images.

In some embodiments, the generation module 1220 may be configured to establish a registration relationship model including multiple registration relationships each of which is of at least two of the multiple images.

In some embodiments, the display module 1230 may be configured to display at least a portion of the multiple registration relationships on a user interface. One of the multiple registration relationships presents at least one of a registration mode, a registration direction, or a reference image for registration between at least two of the multiple images.

In some embodiments, the system 1200 for image registration may further include an adjustment module 1240. The adjustment module 1240 may be configured to obtain a user operation inputted by a user via the user interface, and adjust the registration relationship model based on the user operation.

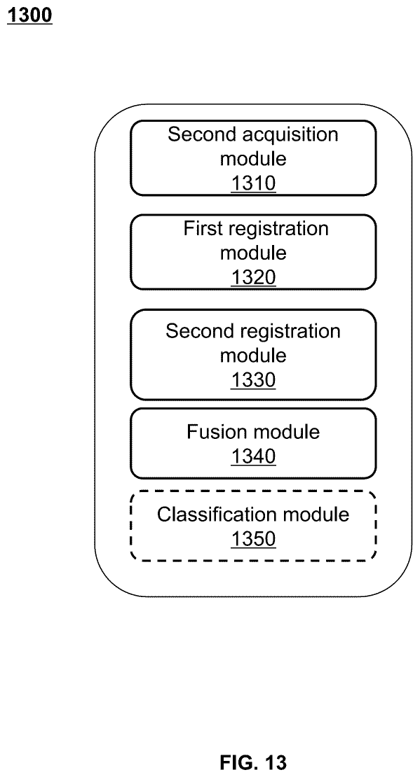

FIG. 13 is a schematic diagram illustrating an exemplary module of an image fusion system according to some embodiments of the present disclosure.

As shown in FIG. 13, the image fusion system 1300 may include a second acquisition module 1310, a first registration module 1320, a second registration module 1330, and a fusion module 1340. In some embodiments, the modules of the medical image fusion system 1300 may be implemented by the processing device 120.

In some embodiments, the second acquisition module 1310 may be similar to the first acquisition module 1210 for obtaining multiple images.

In some embodiments, the first registration module 1320 may be configured to obtain a first registration result based on the multiple images.

In some embodiments, the first registration module 1320 may be configured to obtain the first registration result based on position information of the multiple images.

In some embodiments, the image fusion system 1300 may also include a classification module 1350. The classification module 1350 may be configured to classify the multiple images into multiple groups. In some embodiments, for each group of images, the first registration module 1320 may be configured to obtain a first registration result by registering multiple images in the same group.

In some embodiments, the second registration module 1330 may be configured to obtain a second registration result based on the multiple images and the first registration result.

In some embodiments, the second registration module 1330 may be configured to obtain a second registration result based on gray-level information of the multiple images and the first registration result.

In some embodiments, after classifying the multiple images into multiple groups by the classification module 1350, for each group of images, the second registration module 1330 may be configured to obtain a second registration result by registering multiple images each of which belongs to one of the different groups of images.

In some embodiments, the fusion module 1340 may be configured to fuse the multiple images based on the first registration result and the second registration result.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±1%, ±5%, ±10%, or ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system, comprising:
at least one storage medium including a set of instructions;
at least one processor in communication with the at least one storage medium, wherein when executing the set of instructions, the at least one processor is directed to cause the system to perform operations including:
obtaining multiple images;
establishing a registration relationship model including multiple registration relationships each of which is of at least two of the multiple images; and
displaying at least a portion of the multiple registration relationships on a user interface, wherein one of the multiple registration relationships presents at least one of a registration mode, a registration direction, or a reference image for registration between at least two of the multiple images.

2. The system of claim 1, wherein the operations further include:
obtaining a user operation inputted by a user via the user interface; and
adjusting the registration relationship model based on the user operation, wherein adjustment of the registration relationship model includes at least one of:
modifying at least one of the multiple registration relationships;
adding a registration relationship of at least two of the multiple images; or
deleting a registration relationship of at least two of the multiple images.

3. The system of claim 2, wherein the modifying at least one of the multiple registration relationships includes:
changing at least one of the registration mode, the registration direction, the reference image for registration, or an image to be registered in the at least one of the multiple registration relationships.

4. The system of claim 1, wherein the user interface includes a first visual window configured for displaying of at least one of the multiple images and a second visual window configured for management of the registration relationship model, and the operations further include:
in response to receipt of a selection operation of the user via the first visual window, displaying at least two of the multiple images according to the selection operation;
opening the second visual window; and
managing a registration relationship of the at least two of the multiple images via the second visual window.

5. The system of claim 4, wherein the operations further include:
obtaining a registration result of the at least two of the multiple images that is determined based on the registration relationship;
in response to receipt of an adjusting operation of the user via the second visual window, adjusting the registration result of the at least two of the multiple images.

6. The system of claim 1, wherein the one of the multiple registration relationships is presented on the user interface by a line connecting the at least two of the multiple images, different colors or types of lines representing different registration modes, and the line denotes the registration direction directing from an image to be registered to the reference image among the at least two of the multiple images.

7. (canceled)

8. The system of claim 1, wherein the reference image is highlighted on the user interface.

9. The system of claim 1, wherein the registration mode includes a first registration process based on position information of the multiple images and a second registration process based on gray-level information of the multiple images.

10. The system of claim 1, wherein the operations further include:
classifying the multiple images into multiple groups, the registration relationships of images in a same group presenting a same reference image, images in the same group represent a same portion of a subject, images in the same group correspond to a same coordinate system, images in the same group are acquired by a same scanner, or images in the same group is acquired according to one or more same scanning parameters.

11-12. (canceled)

13. A system, comprising:
at least one storage medium including a set of instructions;
at least one processor in communication with the at least one storage medium, wherein when executing the set of instructions, the at least one processor is directed to cause the system to perform operations including:
obtaining multiple images;
classifying the multiple images into multiple groups;
for each group of images, obtaining a first registration result by registering multiple images in the same group;
for different groups of images, obtaining a second registration result by registering multiple reference images each of which belongs to one of the different groups of images; and
fusing the multiple images based on the first registration result and the second registration result.

14. The system of claim 13, wherein images in a same group represent a same portion of a subject, or images in a same group correspond to a same coordinate system, or images in a same group are acquired by a same scanner, or images in a same group are acquired according to one or more same scanning parameters.

15-17. (canceled)

18. The system of claim 13, wherein the multiple reference images in one group of images corresponds to a maximum field of view among the one group of images or a maximum resolution among the one group of images.

19. (canceled)

20. The system of claim 13, wherein the obtaining a first registration result by registering multiple images in the same group includes:
registering each image in the group of images with the reference image in the group of images by a first registration process performed based on position information and a second registration process based on gray-level information.

21. The system of claim 20, wherein the first registration process is performed by operations including:
determining a first transformation relationship between a first coordinate system applied to the image and a reference coordinate system applied to a subject;
determining a second transformation relationship between a second coordinate system applied to the reference image and the reference coordinate system applied to the subject; and
determining an initial transformation relationship between the first coordinate system and the second coordinate system based on the first transformation relationship and the second transformation relationship.

22. The system of claim 21, wherein the second registration process is performed by operations including:
determining a transformed image by performing an image transform on the image based on an intermediate transformation relationship determined based on the initial transformation relationship;
determining a similarity degree in the grey-level information between the transformed image and the reference image;
determining whether the similarity degree satisfies a condition;
in response to determining that the similarity degree does not satisfy the condition, updating the intermediate transformation relationship until the similarity degree determined based on the updated intermediate transformation relationship satisfies the condition; and
designating the updated intermediate transformation relationship as the target transformation relationship between the first coordinate system and the second coordinate system.

23. The system of claim 13, wherein the obtaining a first registration result by registering multiple images in the same group includes registering one of the multiple images with the reference image in the same group; and the registering multiple reference images each of which belongs to one of the different groups of images includes:
determining a target reference image from the multiple reference images in the different groups of images; and
registering remaining reference images with the target reference image.

24. The system of claim 13, wherein the registering multiple reference images in the different groups of images includes a first registration process performed based on position information and a second registration process based on gray-level information.

25. The system of claim 24, wherein the first registration process is performed by operations including:
for two reference images, determining one or more reference points from each of the two reference images;
matching the one or more reference points determined from each of the two reference images to obtain corresponding reference points in the two reference images; and
determining an initial transformation relationship between a first coordinate system and a second coordinate system applied to the two reference images, respectively, based on the corresponding reference points.

26. The system of claim 25, wherein the second registration process is performed by operations including:
determining a transformed image by performing an image transform on one of the two reference images based on an intermediate transformation relationship determined based on the initial transformation relationship;
determining a similarity degree between the transformed image and another one of the two reference images;
determining whether the similarity degree satisfies a condition;
in response to determining that the similarity degree does not satisfy the condition, updating the intermediate transformation relationship until the similarity degree determined based on the updated intermediate transformation relationship satisfies the condition; and
designating the updated intermediate transformation relationship as the target transformation relationship between the first coordinate system and the second coordinate system.

27. A system, comprising:
at least one storage medium including a set of instructions;
at least one processor in communication with the at least one storage medium, wherein when executing the set of instructions, the at least one processor is directed to cause the system to perform operations including:
obtaining multiple images;
obtaining a first registration result based on position information of the multiple images;
obtaining a second registration result based on gray-level information of the multiple images and the first registration result; and
fusing the multiple images based on the first registration result and the second registration result.

28-39. (canceled)
